(19) United States
(12) Patent Application Publication
(10) Pub. No.: US 2026/0301753 A1
(43) Pub. Date: Oct. 1, 2026

(54) NORMALIZATION FOR MULTI-STAGE QUANTIZATION IN AUDIO CODING USING GAIN-SHAPE RESIDUALS

(71) Applicant: QUALCOMM Incorporated, San Diego, CA (US)

(72) Inventors: Derrick Rea, Broughshane (GB); Megan Lucy Taggart, Newtownabbey (GB); Richard Turner, Belfast (GB); Laurent Wojcieszak, Belfast (GB)

(21) Appl. No.: 19/573,044

(22) Filed: Mar. 20, 2026

Related U.S. Application Data
(60) Provisional application No. 63/781,054, filed on Mar. 31, 2025.
(60) Provisional application No. 63/781,767, filed on Apr. 1, 2025.

(51) Int. Cl. G10L 19/038; G10L 19/002

(52) U.S. Cl. CPC G10L 19/038; G10L 19/002

(57) ABSTRACT

A device comprising a memory and processing circuitry may implement various aspects of the techniques. The memory may be configured to store an encoded audio bitstream representative of audio data. The processing circuitry may be in communication with the memory, and configured to obtain, from the encoded audio bitstream, normalized residual data as 14 bits using a fixed-point signed representation. The processing circuitry may perform inverse multi-stage vector quantization with respect to the normalized residual data to obtain one or more subbands representative of the audio data, and reconstruct, based on the one or more subbands, the audio data. The processing circuitry may render, based on the audio data, one or more speaker feeds, and output, for playback, the one or more speaker feeds.

This application claims the benefit of U.S. Provisional Application No. 63/781,054, filed Mar. 31, 2025, and U.S. Provisional Application No. 63/781,767, filed Apr. 1, 2025, the entire contents of each are hereby incorporated by reference.

This application is also related to U.S. Provisional Application No. 63/656,497, filed Jun. 5, 2024, the entire contents of which are hereby incorporated by reference.

### TECHNICAL FIELD

This disclosure relates to audio encoding and decoding.

### BACKGROUND

Wireless networks for short-range communication, which may be referred to as “personal area networks,” are established to facilitate communication between a source device and a sink device. One example of a personal area network (PAN) protocol is Bluetooth®, which is often used to form a PAN for streaming audio data from the source device (e.g., a mobile phone) to the sink device (e.g., headphones or a speaker).

In some examples, the Bluetooth® protocol is used for streaming encoded or otherwise compressed audio data. In some examples, audio data is encoded using gain-shape vector quantization audio encoding techniques. In gain-shape vector quantization audio encoding, audio data is transformed into the frequency domain and then separated into subbands of transform coefficients. A scalar energy level (e.g., gain) of each subband is encoded separately from the shape (e.g., a residual vector of transform coefficients) of the subband.

### SUMMARY

In general, this disclosure relates to techniques for improving the accuracy of multi-stage pyramid vector quantization through improvements in normalization according to various aspects of the techniques described in this disclosure. Quantization, such as pyramid vector quantization (PVQ), is used in compression of different forms of media such as audio data and video data. To perform PVQ, an audio encoder may map a residual vector to a vector of quantized integers over a hyperspace defined by the PVQ. The audio encoder then performs enumeration to assign a unique identifier (ID) to each code vector on the hyperspace. Enumeration is a lossless process and IDs (which may be referred to as residual IDs) are created in a way to uniquely identify any code vector in the codebook.

The mapping of a vector may be parameterized by N and K. N represents the number of samples in the vector to be quantized and K represents the number of pulses to be included on the N-dimensional hypersurface. Each combination of N (number of coefficients/dimensions) and K (number of pulses) may be represented by a V-value (also referred to as a V-table, V-representation, or V-vector). These V-values may require a large amount of table memory. As such, it would be desirable for an audio encoder (and an audio decoder) to not have to explicitly store all of the V-values.

As opposed to explicitly storing all of the V-values, an audio coder (i.e., an audio encoder or an audio decoder) may store a compact map and use the compact map to generate V-values as needed. The compact map may be generated using a combination of structural unification and relational compression.

In instances where scalable audio coding is required in which bitrates may fluctuate between a relatively lower bitrate and a higher bitrate (e.g., from 80 Kilobits per second—Kbps—to 2 Megabits per second—Mbps), audio processing complexity may increase (in terms of processing cycles performed, memory bus bandwidth, and associated power consumption) while storage requirements for the V-table may also increase as the scalable bitrate adjustment may require additional processing and a different V-table for higher bitrates while the lower bitrate may require a different V-table to accommodate the lower bitrate. While scalable audio coding algorithms, such as a low complexity communications codec (LC3), may allow for low complexity scalable audio coding (which may refer to audio encoding and audio decoding), LC3 may be limited for PAN and other applications due to the proprietary nature of LC3 and other scalable low complexity (which implies low power) instances.

However, scalable audio coding algorithms may be too demanding in terms of computing resources (such as processor complexity, memory bus bandwidth, memory consumption, etc. along with corresponding power) to accommodate implementation in limited computing resource applications that may be encountered for PAN implementations. Employing a vector quantization scheme in a scalable audio bitrate framework may require a number of additional vector tables (V-tables) to accommodate the different bitrates, while higher bitrates may increase processing complexity as the number of vectors with which to quantize the audio data may increase resulting in further processing operations to find a suitable fit to the audio data, thereby potentially increasing processing complexity and memory requirements that may not accommodate low power and/or less complex processing circuitry used in PAN applications.

In accordance with various aspects of the techniques described in this disclosure, low complexity processing circuitry in communication with a memory having limited or fixed storage space may implement multi-stage vector quantization, where each stage may reuse the same V-table and thereby reduce memory consumption while also reducing processing complexity as the residual audio data (resulting from comparing the selected vector to the audio data and/or residual audio data in successive stages) undergoes the same vector quantization as a previous stage. After each stage, the processing circuitry may normalize the residual audio data to facilitate successive vector quantization of the residual audio data (and possibly improve coding performance in terms of total harmonic distortion plus noise—TID+N).

The audio encoder may perform multi-stage vector quantization (such as multi-stage pyramid vector quantization—MS-PVQ) in which the audio encoder performs an initial first stage of PVQ with respect to a frame of the audio data (which may first be transformed into the frequency domain and subdivided into subbands) to obtain a vector representation of the subbands (via a vector table, which may also be referred to as a V-table). The audio encoder may compare each subband to an identified vector from the V-table to obtain residual values. The audio encoder may next normalize the residual values for each subband and perform a successive or second stage of the PVQ with respect to the residual values, repeating the process until the residual values are within a residual threshold and/or a maximum number of stages of PVQ are performed. The audio encoder may then generate, based on the residual values, an encoded audio bitstream, outputting the encoded audio bitstream to an audio decoder.

The audio decoder may extract the encoded residual values (which may be an index into the V-table) and perform inverse multi-stage vector quantization (such as multi-stage inverse PVQ) to obtain the residual values (or a version thereof given that quantization may reduce the accuracy of the residual values). The audio decoder may perform multiple PVQ stages to reconstruct the residual values using the same V-table for each successive stage of the multiple PVQ stages. The audio decoder may reconstruct the audio data based on the multiple residual stages and render the audio data to speaker feeds. The audio decoder may output the speaker feeds to one or more speakers, which may include earbuds, headphones, loudspeakers, or any other form of transducer (including bone conducting transducers). The speakers may reproduce the soundfield represented by the audio data.

In addition, the audio encoder may normalize the error values associated with the quantized residual values after each stage of the PVQ to possibly standardize the error value energy level and maximize the dynamic range of the error values. The audio encoder may normalize the level and quantize the error values using 14 bits in a fixed-point signed representation.

Moreover, when the multistage PVQ is performed after each normalization insert, the accuracy of the PVQ performed by the audio encoder decreases until the number of pulses for each PVQ stage can counteract the size of the normalization bit cost. The first two normalizations are where the largest and most notable drops in accuracy occur, where the audio encoder may perform various aspect of the modified MS-PVQ techniques to compensate for these local minima for purposes of improving accuracy. In a 10-dimensional MS-PVQ, the audio encoder may avoid the local minima and identify the bit allocation values that are to be avoided, signaling the bit allocation for each sample in the encoded audio bitstream.

Furthermore, when the dimensionality of the MS-PVQ is large (relative to lower dimensionality MS-PVQ, e.g., two, three, four, etc. dimensions compared to larger dimensionality like 10, 11, 12, etc. dimensions), the audio encoder may stack multiple codewords to create the pulse count needed before normalization insertion points. Codeword stacking refers to a process whereby multiple shape vector indices are combined to facilitate entropy encoding of the stacked codewords to potentially better compress the audio data (as a result of frequency bands having correlated information and joint encoding allows for better statistical modeling). The number of codewords (C) to be stacked for a N dimensional PVQ is given by C=└N/15┘, where “└ ┘” refers to a round down operation to the nearest integer (e.g., when N is set to 10, └10/15┘ equals 0.6667 and is rounded down to zero). In one example, the number of codewords C to be stacked for an N-dimensional PVQ is calculated using a floor function applied to N divided by 15. The mathematical operation rounds down the result to the nearest integer. For example, when N is set to 10, N divided by 15 equals 0.6667, which is rounded down to zero indicating no stacking. When N is greater than 15, such as 16, the result is rounded down to 1.

In this way, various aspects of the techniques may allow for audio coding that reduces complexity (in terms of the above noted computing resources, such as processing cycles, memory consumption, memory bus bandwidth, etc. and associated power consumption) while improving accuracy via various aspects of the normalization techniques discussed herein. The reduction in complexity occurs because the audio coder (which may refer to one or both of the audio encoder and the audio decoder) may utilize the same PVQ process (e.g., recursively) to encode the residual values along with reusing the same V-table, which reduces memory usage. The recursive nature of the PVQ process may enable the audio encoder to scale the number of stages to accommodate scalable bitrates that may fluctuate between equal to or less than 82 Kilobits per second (Kbps) and equal to or greater than one Megabits per second (Mbps), thereby adapting the bitrate for the encoded audio bitstream to allow for potentially rapid transitions between the lower (82 Kbps) bitrate and the relatively higher (one or more Mbps) that may occur for example when switching between wireless audio delivery and wired audio delivery (e.g., when gaming and transitioning between a wireless audio headset to a wired audio headset).

In addition, the normalization proposed herein in accordance with various aspects of the techniques may enable the audio encoder to normalize the error and maximize the dynamic range of the encoded residuals, which may improve compression and also reproduction of the decoded audio data. The normalization insert points are selected to avoid local minima for accuracy, while codeword stacking may create the pulse counts before normalization insertion points. As such, accuracy of reproduction may be improved due to overall normalization scheme.

In this respect, various aspects of the techniques are directed to a device configured to decode audio data, the device comprising: a memory configured to store an encoded audio bitstream representative of the audio data; and processing circuitry in communication with the memory, the processing circuitry configured to: obtain, from the encoded audio bitstream, normalized residual data as 14 bits using a fixed-point signed representation; perform inverse multi-stage vector quantization with respect to the normalized residual data to obtain one or more subbands representative of the audio data; reconstruct, based on the one or more subbands, the audio data; render, based on the audio data, one or more speaker feeds; and output, for playback, the one or more speaker feeds.

As another example, various aspects of the techniques are directed to a method for decoding audio data, the method comprising: obtaining an encoded audio bitstream representative of the audio data that includes normalized residual data as 14 bits using a fixed-point signed representation; and performing inverse multi-stage vector quantization with respect to the normalized residual data to obtain one or more subbands representative of the audio data; reconstructing, based on the one or more subbands, the audio data; rendering, based on the audio data, one or more speaker feeds; and outputting, for playback, the one or more speaker feeds.

As another example, various aspects of the techniques are directed to a non-transitory computer-readable storage media having stored thereon instructions that, when executed, cause one or more processors to: obtain an encoded audio bitstream representative of audio data that includes normalized residual data as 14 bits using a fixed-point signed representation; and perform inverse multi-stage vector quantization with respect to the normalized residual data to obtain one or more subbands representative of the audio data; reconstruct, based on the one or more subbands, the audio data; render, based on the audio data, one or more speaker feeds; and output, for playback, the one or more speaker feeds.

As another example, various aspects of the techniques are directed to a device configured to encode audio data, the device comprising: a memory configured to store the audio data; and processing circuitry in communication with the memory, the processing circuitry configured to: perform multi-stage vector quantization with respect to one or more subbands of the audio data to obtain quantized audio data, wherein after each stage of the multi-stage vector quantization, the processing circuitry is further configured to normalize an error associated with residual data corresponding to the quantized audio data; generate, based on the quantized audio data, an encoded audio bitstream representative of the audio data; and output, to an audio decoding device, the encoded audio bitstream.

As another example, various aspects of the techniques are directed to a method of encoding audio data, the method comprising: performing multi-stage vector quantization with respect to one or more subbands of the audio data to obtain quantized audio data, wherein after each stage of the multi-stage vector quantization, the method further comprises normalizing an error associated with residual data corresponding to the quantized audio data; generating, based on the quantized audio data, an encoded audio bitstream representative of the audio data; and outputting, to an audio decoding device, the encoded audio bitstream.

As another example, various aspects of the techniques are directed to a non-transitory computer-readable medium having stored thereon instructions that, when executed, cause one or more processors to: perform multi-stage vector quantization with respect to one or more subbands of audio data to obtain quantized audio data, wherein after each stage of the multi-stage vector quantization, the instructions further including instructions, that when executed cause the one or more processors to normalize an error associated with residual data corresponding to the quantized audio data; generate, based on the quantized audio data, an encoded audio bitstream representative of the audio data; and output, to an audio decoding device, the encoded audio bitstream.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a block diagram illustrating a system that may perform various aspects of the techniques described in this disclosure.

FIG. 2A is a block diagram illustrating an example of an audio encoder 24 configured to perform various aspects of the multi-stage pyramid vector quantization (MS-PVQ) normalization techniques described in this disclosure.

FIG. 2B is a block diagram illustrating an example audio encoder that performs various aspects of the MS-PVQ normalization techniques described in this disclosure.

FIG. 3 is a block diagram illustrating an example vector quantizer configured to perform various aspects of the techniques described in this disclosure.

FIG. 4 is a conceptual diagram that illustrates an example hyperpyramid used for performing pyramid vector quantization.

FIG. 5 is a graph illustrating the amount of storage required to explicitly store V-vectors as a function of pulses.

FIG. 6 is a block diagram illustrating an example compact map generation unit, in accordance with one or more techniques of this disclosure.

FIG. 7 is a conceptual diagram illustrating performance of structural unification to generate unified vectors, in accordance with one or more techniques of this disclosure.

FIG. 8 is a block diagram illustrating an example relational compression unit that may perform inter-vector compression, in accordance with one or more techniques of this disclosure.

FIG. 9 is a graph illustrating example memory reductions on unique subbands using inter-vector compression, in accordance with one or more techniques of this disclosure.

FIG. 10 is a block diagram illustrating an example relational compression unit that may perform intra-vector compression, in accordance with one or more techniques of this disclosure.

FIG. 11 is a graph illustrating example memory reductions on unique subbands using intra-vector compression, in accordance with one or more techniques of this disclosure.

FIG. 12 is a flowchart illustrating example operation of the source device of FIG. 1 in performing various aspects of the techniques described in this disclosure.

FIG. 13 is a block diagram illustrating an example audio decoder configured to perform various aspects of the techniques described in this disclosure.

FIG. 14 is a flowchart illustrating example operation of the sink device of FIG. 1 in performing various aspects of the techniques described in this disclosure.

FIG. 15 is a block diagram illustrating example components of the source device shown in the example of FIG. 1.

FIG. 16 is a block diagram illustrating exemplary components of the sink device shown in the example of FIG. 1.

FIG. 17 is a block diagram illustrating an example multi-stage pyramid vector quantization (MS-PVQ) performed by the vector quantizer in accordance with various aspects of the techniques described in this disclosure.

FIG. 18 is a graph illustrating an example of a 10-dimensional MS-PVQ performed by the audio encoder shown in FIG. 1 that avoids a local minima in accordance with various aspects of the techniques described in this disclosure.

FIG. 19 is a flowchart illustrating example operation of the source device of FIG. 1 in performing the techniques described in this disclosure.

FIG. 20 is a flowchart illustrating example operation of the sink device of FIG. 1 in performing the techniques described in this disclosure.

### DETAILED DESCRIPTION

In general, this disclosure relates to techniques for improving the accuracy of multi-stage pyramid vector quantization through improvements in normalization according to various aspects of the techniques described in this disclosure. The mapping of a vector may be parameterized by N and K. N represents the number of samples in the vector to be quantized and K represents the number of pulses to be included on the N-dimensional hypersurface. Each combination of N (number of coefficients/dimensions) and K (number of pulses) may be represented by a V-value (also referred to as a V-table, V-representation, or V-vector). For example, if P(N, K) is an N-dimensional hyper-pyramid with K number of pulses and V(N,K) is a number of vectors with integer components lying on P(N,K), then:

$$\begin{matrix}P ( N , K ) = \{ x : {\sum }_{i = 1}^{N} \vert {x}_{i} \vert = K \} \\ V ( N , K ) = \{ \begin{matrix}the number of vectors x such that \\ {\sum }_{i = 1}^{N} \vert {x}_{i} \vert = K , and {x}_{i} is an integer for i = 1 , … , N\end{matrix}\end{matrix}$$

These V-values may require a large amount of table memory. For example, explicit storage of V-values for 28 subbands may require ~11,302 kB. Larger values of N (i.e., higher dimensions) may cause the storage requirements to grow very quickly. As such, it would be desirable for an audio encoder (and an audio decoder) to not have to explicitly store all of the V-values.

As opposed to explicitly storing all of the V-values, an audio coder (i.e., an audio encoder or an audio decoder) may store a compact map and use the compact map to generate V-values as needed. The compact map may be generated using a combination of structural unification and relational compression.

To perform structural unification, the audio encoder may generate a plurality of unified vectors. As different numbers of coefficients will point to different V-values with different dimensions, hashing can be used to represent data. As such, multiple subbands may be mapped to one unified vector (that is the value of the hash). By generating the unified vectors from all of the different subbands, the audio encoder may remove redundancy between the subbands. For instance, the encoder may perform hashing to generate 6 or 7 unified vectors from 28 subbands.

To preform relational compression, the audio encoder may perform inter-vector or intra-vector compression on the unified vectors. This may result in additional storage savings over just using the unified vectors.

To perform inter-vector compression, the audio encoder may assume a base vector and formulate the remaining vectors as functions of the base vector. As such, to store vectors compressed using inter-vector compression, the audio encoder may explicitly store a base vector and functions that may be applied to the base vector (or other vector generated based on the base vector) to generate vectors.

To perform intra-vector compression, the audio encoder may assume a base vector and generate difference values between subsequent vectors. For instance, as opposed to storing {V₁, V₂, and V₃}, the audio encoder may store {V₁, ΔV₁, and ΔV₂} where V₂=ΔV₁+V₁ and V₃=ΔV₂+V₂, which may consume less storage than the storage normally required for the uncompressed vectors.

While the foregoing compression may allow for more compact V-tables, enabling scalable audio encoding in which target bitrates for the encoded audio bitstream fluctuates (usually within some time threshold—such as 20 milliseconds) between lower bitrates (such as 82 Kilobits per second—Kbps) and relatively higher bitrates (such as one or more Megabits per second—Mbps) may result in different V-tables and/or higher complexity (from a processing cycle perspective) algorithm. In order to reduce both memory and processing cycle consumption, various aspects of the techniques described in this disclosure may enable a multi-stage vector quantization that iteratively (and possibly recursively) performs successive stages of vector quantization with respect to residual values that reduces memory consumption (through reuse of the same V-table in each stage of the multi-stage vector quantization) while potentially avoiding complicated PVQ algorithms that introduce more processing cycles to avoid excessive memory consumption.

In addition, the audio encoder may normalize the error values associated with the quantized residual values after each stage of the PVQ to possibly standardize the error value energy level and maximize the dynamic range of the error values. The audio encoder may normalize the level and quantize the error values using 14 bits in a fixed-point signed representation.

Moreover, when the multistage PVQ is performed after each normalization insert, the accuracy of the PVQ performed by the audio encoder decreases until the number of pulses for each PVQ stage can counteract the size of the normalization bit cost. The first two normalizations are where the largest and most notable drops in accuracy occur, where the audio encoder may perform various aspect of the modified MS-PVQ techniques to avoid these local minima for purposes of improving accuracy.

In a 10-dimensional MS-PVQ, the audio encoder may avoid the local minima and identify the bit allocation values that are to be avoided.

Furthermore, when the dimensionality of the MS-PVQ is large (relative to lower dimensionality MS-PVQ, e.g., two, three, four, etc. dimensions compared to larger dimensionality like 10, 11, 12, etc. dimensions), the audio encoder may stack multiple codewords to create the pulse count needed before normalization insertion points.

Codeword stacking refers to a process whereby multiple shape vector indices are combined to facilitate entropy encoding of the stacked codewords to potentially better compress the audio data (as a result of frequency bands having correlated information and joint encoding allows for better statistical modeling). The number of codewords (C) to be stacked for a N dimensional PVQ is given by C=└N/15┘, where “└ ┘” refers to a round down operation to the nearest integer (e.g., when N is set to 10, └10/15┘ equals 0.6667 and is rounded down to zero).

In this way, the normalization proposed herein in accordance with various aspects of the techniques may enable the audio encoder to normalize the error and maximize the dynamic range of the encoded residuals, which may improve compression and also reproduction of the decoded audio data. The normalization insert points are selected to avoid local minima for accuracy, while codeword stacking may create the pulse counts before normalization insertion points. As such, accuracy of reproduction may be improved due to normalization.

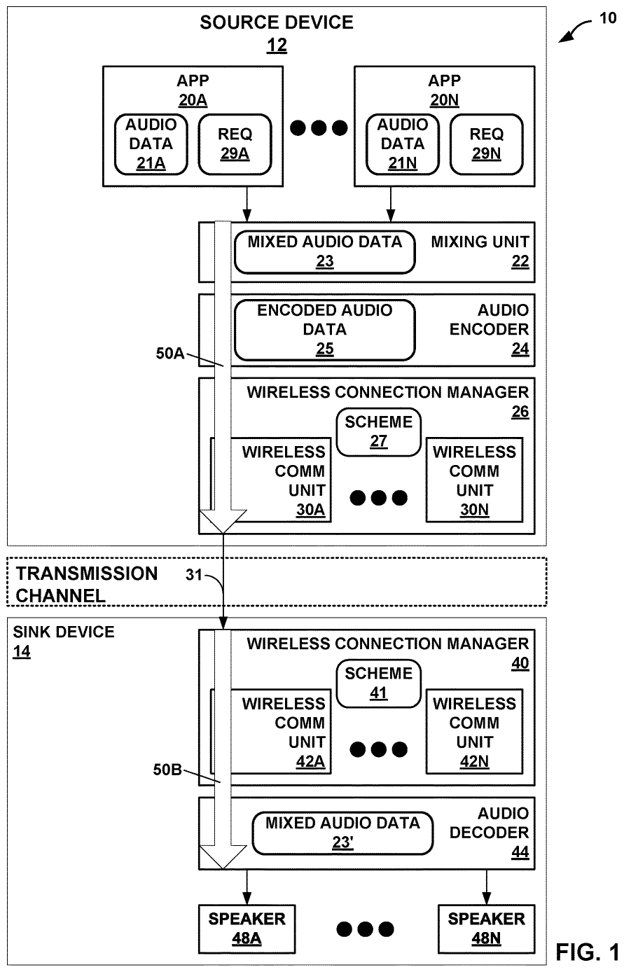

FIG. 1 is a diagram illustrating a system 10 that may perform various aspects of the multi-stage vector quantization normalization techniques described in this disclosure. As shown in the example of FIG. 1, the system 10 includes a source device 12 and a sink device 14. Although described with respect to the source device 12 and the sink device 14, the source device 12 may operate, in some instances, as the sink device, and the sink device 14 may, in these and other instances, operate as the source device. As such, the example of system 10 shown in FIG. 1 is merely one example illustrative of various aspects of the techniques described in this disclosure.

In any event, the source device 12 may represent any form of computing device capable of implementing the techniques described in this disclosure, including a handset (or cellular phone), a tablet computer, a so-called smart phone, a remotely piloted aircraft (such as a so-called “drone”), a robot, a desktop computer, a receiver (such as an audio/visual—AV—receiver), a set-top box, a television (including so-called “smart televisions”), a media player (such as s digital video disc player, a streaming media player, a Blu-Ray Disc™ player, etc.), a virtual reality headset or other wearable headset (including smart glasses), a smart watch, or any other device capable of communicating audio data wirelessly to a sink device via a personal area network (PAN). For purposes of illustration, the source device 12 is assumed to represent a smart phone.

The sink device 14 may represent any form of computing device capable of implementing the techniques described in this disclosure, including a handset (or cellular phone), a tablet computer, a smart phone, a smart watch, smart glasses or other wearable headset (including an extended reality headset), a desktop computer, a wireless headset (which may include wireless headphones that include or exclude a microphone, and so-called smart wireless headphones that include additional functionality such as fitness monitoring, on-board music storage and/or playback, dedicated cellular capabilities, etc.), a wireless speaker (including a so-called “smart speaker”), a watch (including so-called “smart watches”), or any other device capable of reproducing a soundfield based on audio data communicated wirelessly via the PAN. Also, for purposes of illustration, the sink device 14 is assumed to represent wireless headphones.

As shown in the example of FIG. 1, the source device 12 includes one or more applications (“apps”) 20A-20N (“apps 20”), a mixing unit 22, an audio encoder 24, and a wireless connection manager 26. Although not shown in the example of FIG. 1, the source device 12 may include a number of other elements that support operation of apps 20, including an operating system, various hardware and/or software interfaces (such as user interfaces, including graphical user interfaces), one or more processors, memory, storage devices, and the like.

Each of the apps 20 represent software (such as a collection of instructions stored to a non-transitory computer readable media) that configures the system 10 to provide some functionality when executed by the one or more processors of the source device 12. The apps 20 may, to list a few examples, provide messaging functionality (such as access to emails, text messaging, and/or video messaging), voice calling functionality, video conferencing functionality, calendar functionality, audio streaming functionality, direction functionality, mapping functionality, gaming functionality (including streaming gaming functionality), etc. Apps 20 may be first party applications designed and developed by the same company that designs and sells the operating system executed by the source device 12 (and often pre-installed on the source device 12) or third-party applications accessible via a so-called “app store” or possibly pre-installed on the source device 12. Each of the apps 20, when executed, may output audio data 21A-21N (“audio data 21”), respectively. In some examples, the audio data 21 may be generated from a microphone (not pictured) connected to the source device 12.

The mixing unit 22 represents a unit configured to mix one or more of audio data 21A-21N (“audio data 21”) output by the apps 20 (and other audio data output by the operating system—such as alerts or other tones, including keyboard press tones, ringtones, etc.) to generate mixed audio data 23. Audio mixing may refer to a process whereby multiple sounds (as set forth in the audio data 21) are combined into one or more channels. During mixing, the mixing unit 22 may also manipulate and/or enhance volume levels (which may also be referred to as “gain levels”), frequency content, and/or panoramic position of the audio data 21. In the context of streaming the audio data 21 over a wireless PAN session, the mixing unit 22 may output the mixed audio data 23 to the audio encoder 24.

The audio encoder 24 may represent a unit configured to encode the mixed audio data 23 and thereby obtain encoded audio data 25. In some examples, the audio encoder 24 may encode individual ones of the audio data 21. Referring for purposes of illustration to one example of the PAN protocols, Bluetooth® provides for a number of different types of audio codecs (which is a word resulting from combining the words “encoding” and “decoding”) and is extensible to include vendor specific audio codecs. The Advanced Audio Distribution Profile (A2DP) of Bluetooth® indicates that support for A2DP involves supporting a subband codec specified in A2DP. A2DP also supports codecs set forth in MPEG-1 Part 3 (MP2), MPEG-2 Part 3 (MP3), MPEG-2 Part 7 (advanced audio coding—AAC), MPEG-4 Part 3 (high efficiency-AAC—HE-AAC), and Adaptive Transform Acoustic Coding (ATRAC). Furthermore, as noted above, A2DP of Bluetooth® supports vendor specific codecs, such as aptX™ and various other versions of aptX (e.g., enhanced aptX—E-aptX, aptX live, and aptX high definition—aptX-HD).

The audio encoder 24 may operate consistent with one or more of any of the above listed audio codecs, as well as, audio codecs not listed above, but that operate to encode the mixed audio data 23 to obtain the encoded audio data 25. The audio encoder 24 may output the encoded audio data 25 to one of the wireless communication units 30 (e.g., the wireless communication unit 30A) managed by the wireless connection manager 26. As described in more detail below, the audio encoder 24 may be configured to encode the audio data 21 and/or the mixed audio data 23 using a compact map.

The wireless connection manager 26 may represent a unit configured to allocate bandwidth within certain frequencies of the available spectrum to the different ones of the wireless communication units 30. For example, the Bluetooth® communication protocols operate over within the 2.5 GHz range of the spectrum, which overlaps with the range of the spectrum used by various wireless local area network (WLAN) communication protocols. The wireless connection manager 26 may allocate some portion of the bandwidth during a given time to the Bluetooth® protocol and different portions of the bandwidth during a different time to the overlapping WLAN protocols.

The allocation of bandwidth and other parameters is defined by a scheme 27. The wireless connection manager 26 may expose various application programmer interfaces (APIs) by which to adjust the allocation of bandwidth and other aspects of the communication protocols so as to achieve a specified quality of service (QoS). That is, the wireless connection manager 26 may provide the API to adjust the scheme 27 by which to control operation of the wireless communication units 30 to achieve the specified QoS. The QoS may be adaptable to provide for scalable audio coding in which the bitrate of the bitstream 31 changes (often within some time threshold, such as 20 milliseconds—ms) between a low bitrate (e.g., equal to or less than 82 Kbps) and a relatively higher bitrate (e.g., one or more Mbps).

In other words, the wireless connection manager 26 may manage coexistence of multiple wireless communication units 30 that operate within the same spectrum, such as certain WLAN communication protocols and some PAN protocols as discussed above. The wireless connection manager 26 may include a coexistence scheme 27 (shown in FIG. 1 as “scheme 27”) that indicates when (e.g., an interval) and how many packets each of the wireless communication units 30 may send, the size of the packets sent, and the like.

The wireless communication units 30 may each represent a wireless communication unit 30 that operates in accordance with one or more communication protocols to communicate encoded audio data 25 via a transmission channel to the sink device 14. In the example of FIG. 1, the wireless communication unit 30A is assumed for purposes of illustration to operate in accordance with the Bluetooth® suite of communication protocols. It is further assumed that the wireless communication unit 30A operates in accordance with A2DP to establish a PAN link (over the transmission channel) to allow for delivery of the encoded audio data 25 from the source device 12 to the sink device 14.

In additional examples, the wireless communication unit 30A operates in accordance with a High Data Throughput (HDT) standard to establish the transmission channel link. The encoded audio data 25 generated by the audio encoder 24 is formatted to comply with HDT requirements for advanced Bluetooth or other wireless communication standards to ensure maximum precision is achieved during playback at the sink device 14.

More information concerning the Bluetooth® suite of communication protocols can be found in a document entitled “Bluetooth Core Specification v 5.0,” published Dec. 6, 2016, and available at: www.bluetooth.org/en-us/specification/adopted-specifications. More information concerning A2DP can be found in a document entitled “Advanced Audio Distribution Profile Specification,” version 1.3.1, published on Jul. 14, 2015.

The wireless communication unit 30A may output the encoded audio data 25 as the bitstream 31 to the sink device 14 via a transmission channel, which may be a wired or wireless channel, a data storage device, or the like. While shown in FIG. 1 as being directly transmitted to the sink device 14, the source device 12 may output the bitstream 31 to an intermediate device positioned between the source device 12 and the sink device 14. The intermediate device may store the bitstream 31 for later delivery to the sink device 14, which may request the bitstream 31. The intermediate device may comprise a file server, a web server, a desktop computer, a laptop computer, a tablet computer, a mobile phone, a smart phone, a smart watch, smart glasses, a head mounted display (e.g., a virtual reality headset, an extended reality headset, an augmented reality headset, and the like) or any other device capable of storing the bitstream 31 for later retrieval by an audio decoder. This intermediate device may reside in a content delivery network capable of streaming the bitstream 31 (and possibly in conjunction with transmitting a corresponding video data bitstream) to subscribers, such as the sink device 14, requesting the bitstream 31.

Alternatively, the source device 12 may store the bitstream 31 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to those channels by which content stored to these mediums are transmitted (and may include retail stores and other store-based delivery mechanism). In any event, the techniques of this disclosure should not therefore be limited in this respect to the example of FIG. 1.

As further shown in the example of FIG. 1, the sink device 14 includes a wireless connection manager 40 that manages one or more of wireless communication units 42A-42N (“wireless communication units 42”) according to a scheme 41, an audio decoder 44, and one or more speakers 48A-48N (“speakers 48”). The wireless connection manager 40 may operate in a manner similar to that described above with respect to the wireless connection manager 26, exposing an API to adjust scheme 41 by which operation of the wireless communication units 42 achieve a specified QoS.

The wireless communication units 42 may be similar in operation to the wireless communication units 30, except that the wireless communication units 42 operate reciprocally to the wireless communication units 30 to decapsulate the encoded audio data 25. One of the wireless communication units 42 (e.g., the wireless communication unit 42A) is assumed to operate in accordance with the Bluetooth® suite of communication protocols and reciprocal to the wireless communication protocol 30A. The wireless communication unit 42A may output the encoded audio data 25 to the audio decoder 44.

The audio decoder 44 may operate in a manner that is reciprocal to the audio encoder 24. The audio decoder 44 may operate consistent with one or more of any of the above listed audio codecs, as well as, audio codecs not listed above, but that operate to decode the encoded audio data 25 to obtain mixed audio data 23′. The prime designation with respect to “mixed audio data 23” denotes that there may be some loss due to quantization or other lossy operations that occur during encoding by the audio encoder 24. The audio decoder 44 may render and output the mixed audio data 23′ to one or more of the speakers 48. The audio decoder 44 may render the mixed audio data 23′ to speaker feeds, which are then used to drive the speakers 48. The speakers 48 may represent any form of transducer that reproduces a soundfield based on the speaker feeds, where the transducer may represent ear buds, headphones, loudspeakers, and the like in any form, including bone transducing headphones, planar magnetic headphones, in-ear monitors, etc.

Each of the speakers 48 represent a transducer configured to reproduce a soundfield from the mixed audio data 23′. The transducer may be integrated within the sink device 14 as shown in the example of FIG. 1 or may be communicatively coupled to the sink device 14 (via a wire or wirelessly). The speakers 48 may represent any form of speaker, such as a loudspeaker, a headphone speaker, or a speaker in an earbud. Furthermore, although described with respect to a transducer, the speakers 48 may represent other forms of speakers, such as the “speakers” used in bone conducting headphones that send vibrations to the upper jaw, which induces sound in the human aural system.

As noted above, the apps 20 may output audio data 21 to the mixing unit 22. Prior to outputting the audio data 21, the apps 20 may interface with the operating system to initialize an audio processing path for output via integrated speakers (not shown in the example of FIG. 1) or a physical connection (such as a mini-stereo audio jack, which is also known as 3.5 millimeter—mm—minijack). As such, the audio processing path may be referred to as a wired audio processing path considering that the integrated speaker is connected by a wired connection similar to that provided by the physical connection via the mini-stereo audio jack. The wired audio processing path may represent hardware or a combination of hardware and software that processes the audio data 21 to achieve a target quality of service (QoS), which may specify a signal-to-noise-ratio (SNR) to achieve a target bitrate and provide a total harmonic distortion plus noise (THID+N).

To illustrate, one of the apps 20 (which is assumed to be the app 20A for purposes of illustration) may issue, when initializing or reinitializing the wired audio processing path, a request 29A for a particular QoS for the audio data 21A output by the app 20A. The request 29A may specify, as a couple of examples, a high latency (that results in high quality) wired audio processing path, a low latency (that may result in lower quality) wired audio processing path, or some intermediate latency wired audio processing path. The low latency wired audio processing path may also be referred to as a high quality wired audio processing path, while the relatively higher latency wired audio processing path may also be referred to as a low quality wired audio processing path.

In addition, the request 29A may specify a high quality wireless audio processing path, a low quality wireless audio processing path, and some intermediate quality processing path. The apps 20 may dynamically adapt the audio processing path to accommodate switching between various audio processing paths, such as is common in gaming instances in which the user switches between a wireless audio processing path (e.g., using a PAN) and a wired audio processing path (or a higher bandwidth wireless audio processing path, such as that provided by WiFi™). Whether a high latency, low latency, or intermediate latency is selected for either a wired or wireless audio processing path, the app 20A may issue the request 29A to dynamically adapt audio processing to accommodate the user preference, where typically such dynamical adaptation of the audio processing path is required to be performed within some time threshold (e.g., 20 milliseconds—ms).

As such, the audio encoder 24 may perform scalable audio encoding to dynamically transition encoding to accommodate the different audio processing paths, where high latency, low quality audio processing is performed for bandwidth limited transmission channels (as is common via PAN connections) and low latency, high quality audio processing is performed for relatively higher bandwidth transmission channels (as is common via wired or higher bandwidth wireless connections). As one example, the app 20A may represent a gaming application 20A (and may be referred to as “gaming app 20A”), and the user may switch between a PAN transmission channel and a wired or (wireless, but wide area network—WAN—connection) having a higher bandwidth compared to the PAN transmission channel. In these instances, the audio encoder 24 may transition the audio encoding between a lower and higher bitrate to satisfy the requirements of the different transmission channels (e.g., PAN versus WAN and/or wired).

In instances where scalable audio coding is utilizes in which bitrates may fluctuate between a relatively lower bitrate and a higher bitrate (e.g., from 80 Kilobits per second—Kbps—to one or more Megabits per second—Mbps), audio processing complexity may increase (in terms of processing cycles performed, memory bus bandwidth, and associated power consumption) while storage requirements for the V-table may also increase as the scalable bitrate adjustment may require additional processing and a different V-table for higher bitrates while the lower bitrate may require a different V-table to accommodate the lower bitrate. While scalable audio coding algorithms may allow for low complexity scalable audio coding (which may refer to audio encoding and audio decoding), low complexity scalable audio coding may be limited for PAN and other applications due to the proprietary nature of certain low complexity (which implies low power) scalable audio coding instances.

However, scalable audio coding algorithms may be too demanding in terms of computing resources (such as processor complexity, memory bus bandwidth, memory consumption, etc. along with corresponding power) to accommodate implementation in limited computing resource applications that may be encountered for PAN implementations. Employing a vector quantization scheme in a scalable audio bitrate framework may require a number of additional vector tables (V-tables) to accommodate the different bitrates, while higher bitrates may increase processing complexity as the number of vectors with which to quantize the audio data 23 may increase resulting in further processing operations to find a suitable fit to the audio data 23, thereby potentially increasing processing complexity and memory requirements that may not accommodate low power and/or less complex processing circuitry used in PAN applications.

Moreover, various normalization algorithms may increase complexity without overly improving reproduction of the mixed audio data 23 at the sink device 14. Normalization refers to a process whereby the residual data is normalized (often using L2 normalization) to improve the energy level while also maximizing the dynamic range. Various codecs seek to reduce complexity, improve reproduction (or, in other words, accuracy), and otherwise limit resource utilization, the MS-PVQ offered in a number of different codecs suffer in various ways due to the limited use of normalization.

For example, prior methods utilizing multi-stage PVQ for gain-shape codec residuals exhibit spikes in the THD+N measurement when frequency sweeps are applied. Such spikes indicate a decrease in performance in the codec. The audio encoder 24 addresses these performance decreases by utilizing improved normalization values and avoiding accuracy decreases during the quantization stages.

In accordance with various aspects of the techniques described in this disclosure, low complexity processing circuitry (e.g., the audio encoder 24) in communication with a memory (not shown in FIG. 1 for ease of illustration purposes) having limited or fixed storage space may implement multi-stage vector quantization, where each stage may reuse the same V-table and thereby avoid extensive memory consumption while also reducing processing complexity as the residual audio data (resulting from comparing the selected vector to the audio data and/or residual audio data in successive stages) undergoes the same vector quantization as a previous stage. After each stage, the processing circuitry (e.g., represented by the audio encoder 24) may normalize the residual audio data to facilitate successive vector quantization of the residual audio data (and possibly improve coding performance in terms of total harmonic distortion plus noise—THD+N).

The audio encoder 24 may improve normalization by performing, after each successive stage of the MS-PVQ, normalization with respect to an error associated with the quantized residual to standardize the errors energy level and maximize its dynamic range (which results possibly in better compression with improved reproduction, meaning the reproduced audio data is more bit accurate when compared to non-normalized error values). The audio encoder 24 may achieve a raw normalization level where the error values are now quantized using 14 bits in a fixed-point signed representation.

The audio encoder 24 may perform multi-stage vector quantization (such as multi-stage pyramid vector quantization—PVQ) in which the audio encoder 24 performs an initial first stage of PVQ with respect to a frame of the audio data 23 (which may first be transformed into the frequency domain and subdivided into subbands) to obtain a vector representation of the subbands (via a vector table, which may also be referred to as a V-table). The audio encoder 24 may compare each subband to an identified vector from the V-table to obtain the residual audio values. The audio encoder 24 may next normalize the residual values for each subband and perform a successive or second stage of the PVQ with respect to the residual values, repeating the process (including normalization using, as one example, 14 bits in a fixed-point signed representation) until the residual values are within a residual threshold and/or a maximum number of stages of PVQ are performed.

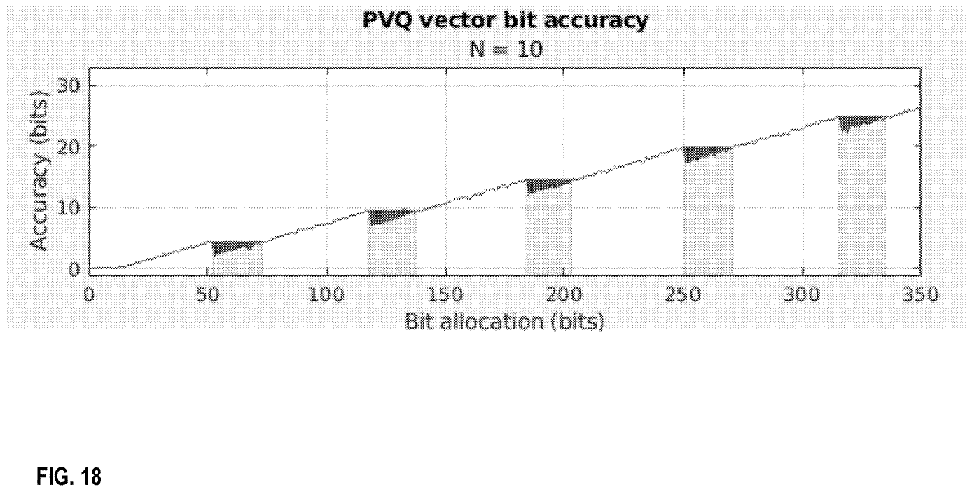

The audio encoder 24 may avoid accuracy decreases using normalization. That is, when the audio encoder 24 performs each stage of the MS-PVQ after each normalization insert, the accuracy of the MS-PVQ drops until the number of pulses for each MS-PVQ stage can counteract the size of the normalization bit cost. As the first two normalizations are where the largest and most notable drops in accuracy occur, the audio encoder 24 may perform various aspects of the normalization techniques to avoid these local minima for accuracy. Referring to the example of FIG. 18, an example of a 10-dimensional MS-PVQ illustrates the local minima (in dark gray) and the bit allocation values that the audio encoder 24 may avoid.

Further, the audio encoder 24 may perform codeword stacking for higher dimensionality MS-PVQ. When the dimensionality of the PVQ is large, the audio encoder 24 may stack multiple codewords (which is another way of referring to the unique ID into the V-table, or in other words, the vector identifier) to create the pulse count needed before normalization insertion points. The number of codewords (C) to be stacked for a N dimensional PVQ is given by C=└N/15┘, where “└ ┘” refers to a round down operation to the nearest integer (e.g., when N is set to 10, └10/15┘ equals 0.6667 and is rounded down to zero—or in other words, no stacking, while when N is greater than 15, such as 16, C=└16/15┘, which is rounded down to 1). The audio encoder 24 may entropy encode (e.g., Golomb-Rice coding, Huffman coding, arithmetic coding, etc.) the stacked codewords to obtain entropy encoded stacked codewords.

The audio encoder 24 may then generate, based on the residual values (which in some instances may be represented by the entropy encoded stacked codewords), an encoded audio bitstream 31. The audio encoder 24 may also specify the bit allocation value (or, in other words, the bit allocation) in the encoded audio data 25 (e.g., an encoded audio bitstream). The audio encoder 24 may then output the encoded audio bitstream to the audio decoder 44 via the transmission channel.

The audio decoder 44 may extract the bit allocation for the residual values along with the encoded residual values (which may be an index into the V-table or the entropy encoded stacked codeword discussed above) and perform inverse multi-stage vector quantization (such as multi-stage inverse PVQ) to obtain the normalized residual values (or a version thereof given that quantization may reduce the accuracy of the residual values, as denoted by the prime notation on the mixed audio data 23′, although potentially improved due to various aspects of the normalization techniques described herein). The audio decoder 44 may perform multiple PVQ stages to reconstruct the residual values using the same V-table for each successive stage of the multiple PVQ stages. The audio decoder 44 may reconstruct the audio data 23′ based on the multiple residual stages and render the audio data 23′ to speaker feeds. The audio decoder 44 may output the speaker feeds to one or more speakers 48, which may include earbuds, headphones, loudspeakers, or any other form of transducer. The speakers 48 may reproduce the soundfield represented by the audio data 23′.

In operation, the audio encoder 24 may perform multi-stage vector quantization with respect to one or more subbands of the audio data to obtain quantized audio data. Prior to performing vector quantization (such as PVQ), the audio encoder 24 may apply a transform to the mixed audio data 23 to convert the mixed audio data 23 from the time domain to the frequency domain. The transform may include a modified discrete cosine transform (MDCT), whereupon the audio encoder 24 may divide the transformed audio data into the one or more subbands. The audio encoder 24 may next perform the multi-stage PVQ (in one example) to obtain the quantized audio data, which is another way to refer to indexes into the V-table that identify the matching vector.

The audio encoder 24 may apply each stage of the multi-stage PVQ iteratively (and possibly recursively) to obtain, after each stage, residual values. The audio encoder 24 may then normalize, after each stage of the multi-stage PVQ, the residual values (which are the result of subtracting the vector from the V-table from each subband of transformed audio data, where the difference may also be referred to as error values). The audio encoder 24 may apply a L2-norm to the residual values to reduce the dynamic range, which may improve successive stages of application of the PVQ.

In other words, the audio encoder 24 may perform, after each PVQ stage, normalization to the error associated with the residual values to standardize the energy level and maximize the dynamic range of the error values associated with the residual values. The raw normalization level may not be quantized using 14 bits in a fixed-point signed representation. Further, the audio encoder 24 may also avoid local minima (per the example shown in FIG. 18) to potentially improve accuracy.

The audio encoder 24 may specify the vector indexes (or differences as residual data) in the encoded audio bitstream 31 after each stage of the multi-stage PVQ. The audio encoder 24 may then generate, based on the quantized audio data, the encoded audio bitstream 31 (which encapsulates the encoded audio data 25) representative of the audio data 23 along with the bit allocation. As noted above, the audio encoder 24 may specify the vector indexes as a stacked codeword for higher dimensionality MS-PVQ encoding. The audio encoder 24 may then interface with the wireless connection manager 26 to output, via one of the wireless communication units 30, the encoded audio bitstream 31 (possibly to sink device 14 or some intermediate device not shown in the example of FIG. 1).

The audio decoder 44 may receive, via the transmission channel and the wireless connection manager 40, the encoded audio bitstream 31. The audio decoder 44 may perform inverse multi-stage vector quantization, based possibly on the bit allocation extracted from the encoded audio bitstream 31, with respect to the encoded audio bitstream 31 to obtain one or more subbands representative of the audio data 23. The audio decoder 44 may perform inverse operations to the audio encoder 24 to apply each stage of the inverse multi-stage PVQ (as one example) to obtain the normalized residual values, adding the normalized residual values to the vector from the V-table signaled in the bitstream. The audio decoder 44 may then iteratively (and possibly recursively) perform each stage of the multi-stage PVQ to reconstruct the audio data 23 as mixed audio data 23′.

In order to reconstruct the audio data 23, the audio decoder 44 may reconstruct, based on the one or more subbands (recombined from the gain and shape vector), the audio data 23′, where again the prime notation reflects that some loss occurs as a result of the PVQ process inasmuch as the PVQ process is not lossless. The audio decoder 44 may apply the inverse transform (inverse MDCT which may be denoted as iMDCT) to the audio data 23′ to convert the audio data 23′ from the frequency domain to the time domain. The audio decoder 44 may next render the audio data 23′ to speaker feeds, and output the speaker feeds to speakers 48 so that the speakers 48 may reproduce the soundfield.

In this way, various aspects of the techniques may allow for audio coding that reduces complexity (in terms of the above noted computing resources, such as processing cycles, memory consumption, memory bus bandwidth, etc. and associated power consumption). The reduction in complexity occurs because the audio coder 24/44 (which may refer to one or both of the audio encoder 24 and the audio decoder 44) may utilize the same PVQ process (e.g., recursively) to encode the residual values along with reusing the same V-table, which reduces memory usage. The recursive nature of the PVQ process may enable the audio encoder 24 to scale the number of stages to accommodate scalable bitrates that may fluctuate between equal to or less than 82 Kilobits per second (Kbps) and equal to or greater than one Megabits per second (Mbps), thereby adapting the bitrate for the encoded audio bitstream 31 to allow for potentially rapid transitions between the lower (82 Kbps) bitrate and the relatively higher (one or more Mbps) that may occur for example when switching between wireless audio delivery and wired audio delivery (e.g., when gaming and transitioning between a wireless audio headset to a wired audio headset).

In addition, the normalization proposed herein in accordance with various aspects of the techniques may enable the audio encoder 24 to normalize the error and maximize the dynamic range of the encoded residuals, which may improve compression and also reproduction of the decoded audio data 23′. The audio encoder 24 may select the normalization insert points to avoid local minima for accuracy, while codeword stacking may create the pulse counts before normalization insertion points. As such, accuracy of reproduction may be improved due to normalization (possibly enabling lossless audio data at low complexity and over a PAN).

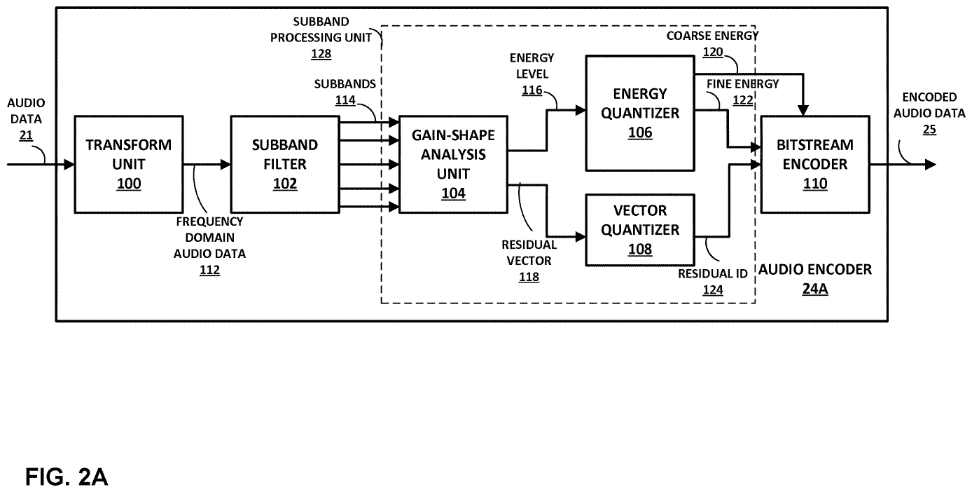

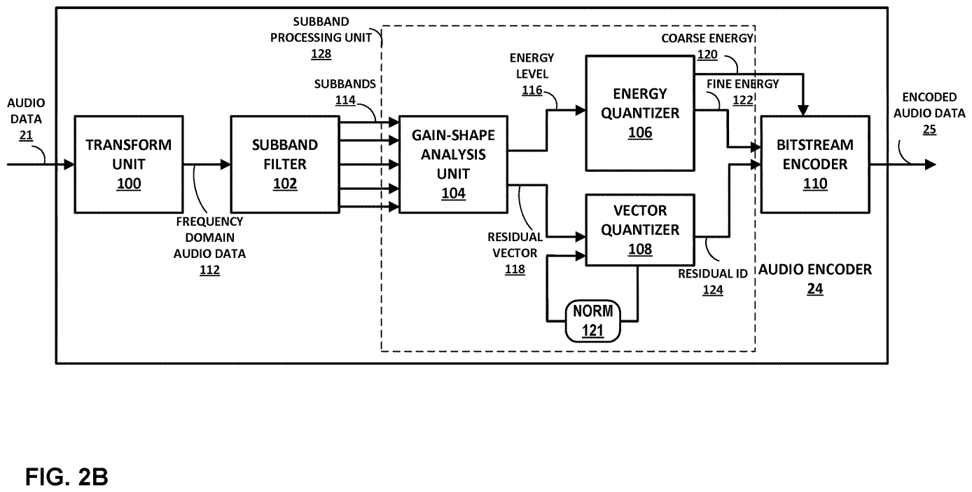

FIG. 2A is a block diagram illustrating an example of an audio encoder 24 configured to perform various aspects of the MS-PVQ normalization techniques described in this disclosure. The audio encoder 24A may represent audio encoder 24 shown in FIG. 1 and may be configured to encode audio data for transmission over a PAN (e.g., Bluetooth®). However, the techniques of this disclosure performed by the audio encoder 24 may be used in any context where the compression of audio data is desired. In some examples, the audio encoder 24A may be configured to encode the audio data 21 in accordance with as aptX™ audio codec, including, e.g., enhanced aptX—E-aptX, aptX live, and aptX high definition. However, the techniques of this disclosure may be used in any audio codec configured to perform pyramid vector quantization (PVQ) or other vector quantization of audio data involving normalization.

As will be explained in more detail below, the audio encoder 24A may be configured to perform various aspects of a PVQ process using compact maps and/or normalization.

In the example of FIG. 2A, the audio encoder 24A may be configured to encode the audio data 21 (or the mixed audio data 23) using a gain-shape vector quantization encoding process that includes coding residual vector using compact maps (or a standard vector table—V-table). In a gain-shape vector quantization encoding process, the audio encoder 24A is configured to encode both a gain (e.g., an energy level) and a shape (e.g., a residual vector defined by transform coefficients) of a subband of frequency domain audio data. Each subband of frequency domain audio data represents a certain frequency range of a particular frame of the audio data 21.

The audio data 21 may be sampled at a particular sampling frequency. Example sampling frequencies may include 48 kHz or 44.1 kHZ, though any desired sampling frequency may be used. Each digital sample of the audio data 21 may be defined by a particular input bit depth, e.g., 16 bits or 24 bits. In one example, the audio encoder 24A may be configured operate on a single channel of the audio data 21 (e.g., mono audio). In another example, the audio encoder 24A may be configured to independently encode two or more channels of the audio data 21. For example, the audio data 21 may include left and right channels for stereo audio. In this example, the audio encoder 24A may be configured to encode the left and right audio channels independently in a dual mono mode. In other examples, the audio encoder 24A may be configured to encode two or more channels of the audio data 21 together (e.g., in a joint stereo mode). For example, the audio encoder 24A may perform certain compression operations by predicting one channel of the audio data 21 from another channel of the audio data 21.

Regardless of how the channels of the audio data 21 are arranged, the audio encoder 24A receives the audio data 21 and sends that audio data 21 to a transform unit 100. The transform unit 100 is configured to transform a frame of the audio data 21 from the time domain to the frequency domain to produce frequency domain audio data 112. A frame of the audio data 21 may be represented by a predetermined number of samples of the audio data. In one example, a frame of the audio data 21 may be 1024 samples wide. Different frame widths may be chosen based on the frequency transform being used and the amount of compression desired. The frequency domain audio data 112 may be represented as transform coefficients, where the value of each of the transform coefficients represents an energy of the frequency domain audio data 112 at a particular frequency.

In one example, the transform unit 100 may be configured to transform the audio data 21 into the frequency domain audio data 112 using a modified discrete cosine transform (MDCT). An MDCT is a “lapped” transform that is based on a type-IV discrete cosine transform. The MDCT is considered “lapped” as it works on data from multiple frames. That is, in order to perform the transform using an MDCT, transform unit 100 may include a fifty percent overlap window into a subsequent frame of audio data. The overlapped nature of an MDCT may be useful for data compression techniques, such as audio encoding, as it may reduce artifacts from coding at frame boundaries. The transform unit 100 need not be constrained to using an MDCT but may use other frequency domain transformation techniques for transforming the audio data 21 into the frequency domain audio data 112.

A subband filter 102 separates the frequency domain audio data 112 into subbands 114. Each of the subbands 114 includes transform coefficients of the frequency domain audio data 112 in a particular frequency range. For instance, the subband filter 102 may separate the frequency domain audio data 112 into twenty different subbands. In some examples, the subband filter 102 may be configured to separate the frequency domain audio data 112 into the subbands 114 of uniform frequency ranges. In other examples, the subband filter 102 may be configured to separate the frequency domain audio data 112 into the subbands 114 of non-uniform frequency ranges.

For example, the subband filter 102 may be configured to separate the frequency domain audio data 112 into the subbands 114 according to the Bark scale. In general, the subbands 114 of a Bark scale have frequency ranges that are perceptually equal distances. That is, the subbands of the Bark scale are not equal in terms of frequency range, but rather, are equal in terms of human aural perception. In general, the subbands 114 at the lower frequencies will have fewer transform coefficients, as lower frequencies are easier to perceive by the human aural system. As such, the frequency domain audio data 112 in lower frequency subbands of the subbands 114 is less compressed by the audio encoder 24A, as compared to higher frequency subbands. Likewise, higher frequency subbands of the subbands 114 may include more transform coefficients, as higher frequencies are harder to perceive by the human aural system. As such, the frequency domain audio data 112 in higher frequency subbands of the subbands 114 may be more compressed by the audio encoder 24A, as compared to lower frequency subbands.

The audio encoder 24A may be configured to process each of the subbands 114 using a subband processing unit 128. That is, the subband processing unit 128 may be configured to process each of the subbands separately. The subband processing unit 128 may be configured to perform a gain-shape vector quantization process with extended-range coarse-fine quantization.

A gain-shape analysis unit 104 may receive the subbands 114 as an input. For each of the subbands 114, the gain-shape analysis unit 104 may determine an energy level 116 of each of the subbands 114. That is, each of the subbands 114 has an associated energy level 116. The energy level 116 is a scalar value in units of decibels (dBs) that represents the total amount of energy (also called gain) in the transform coefficients of a particular one of the subbands 114. The gain-shape analysis unit 104 may separate the energy level 116 for one of the subbands 114 from the transform coefficients of the subbands 114 to produce residual vector 118. The residual vector 118 represents the so-called “shape” of the subband. The shape of each of the subbands 114 may also be referred to as the spectrum of the subband.

A vector quantizer 108 may be configured to quantize the residual vector 118. In one example, the vector quantizer 108 may quantize the residual vector using a pyramid vector quantization (PVQ) process to produce the residual ID 124. Instead of quantizing each sample separately (e.g., scalar quantization), the vector quantizer 108 may be configured to quantize a block of samples included in the residual vector 118 (e.g., a shape vector). In some examples, the vector quantizer 108 may use a Linde-Buzo-Gray (LBG) algorithm to perform the vector quantization. A Linde-Buzo-Gray (LBG) algorithm typically results in less distortion with a fixed available bit-rate compared to scalar quantization. However, any vector quantization technique can be used along with the normalization techniques of this disclosure.

A structured vector quantization may involve performing the quantization based upon a set of structured code-vectors that do not need to be stored explicitly and can be identified functionally. Examples of the structured vector quantizers include Lattice vector quantizers and Pyramid Vector Quantizers (PVQ). One example of how PVQ may be used is described in A. C. Hung, E. K. Tsern and T. H. Meng, “Error-resilient pyramid vector quantization for image compression,” in IEEE Transactions on Image Processing, vol. 7, no. 10, pp. 1373-1386, October 1998. Using PVQ, the vector quantizer 108 may be configured to map the residual vector 118 to a hyperpyramid (with constant L1 norm) or a hypersphere (with constant L2 norm) and quantize the residual vector 118 upon the underlying structured codebook. The quantization code-vectors are then enumerated and assigned an ID (e.g., the residual ID 124) to be encoded and transmitted. The quality of the mapping drives the accuracy of the quantization, while the number of enumeration code-vectors specifies the shape transmission rate.

In some examples, the audio encoder 24A may dynamically allocate bits for coding the energy level 116 and the residual vector 118. That is, for each of the subbands 114, the audio encoder 24A may determine the number of bits allocated for energy quantization (e.g., by the energy quantizer 106) and the number of bits allocated for vector quantization (e.g., by the vector quantizer 108). As noted herein, the vector quantizer 108 may identify local minima and adjust the bit allocation to avoid the local minima (as noted in the graph set forth in the example of FIG. 18, which shows an example of a 10-dimensional PVQ where the dark gray denotes the local minima and the bit allocation values that are to be avoided). As will be explained in more detail below, the total number of bits allocated for energy quantization may be referred to as energy-assigned bits. These energy-assigned bits may then be allocated between a coarse quantization process and a fine quantization process.

After each stage of the MS-PVQ, the vector quantizer 108 may quantize the residual to normalize the energy level and promote the dynamic range. The vector quantizer 108 may output the quantized vector (which may refer to the residual ID 124) as an entropy encoded stacked codeword (when higher dimensional PVQ is performed where the stacking is controlled by the equation noted above).

An energy quantizer 106 may receive the energy level 116 of the subbands 114 and quantize the energy level 116 of the subbands 114 into a coarse energy 120 and a fine energy 122. This disclosure describes the quantization process for one subband, but it should be understood that the energy quantizer 106 may perform energy quantization on one or more of the subbands 114, including each of the subbands 114.

The energy quantizer 106 may perform a two-step quantization process. Energy quantizer 106 may first quantize the energy level 116 with a first number of bits for a coarse quantization process to generate the coarse energy 120. The energy quantizer 106 may generate the coarse energy using a predetermined range of energy levels for the quantization (e.g., the range defined by a maximum and a minimum energy level). The coarse energy 120 approximates the value of the energy level 116.

The energy quantizer 106 may then determine a difference between the coarse energy 120 and the energy level 116. This difference is sometimes called a quantization error. The energy quantizer 106 may then quantize the quantization error using a second number of bits in a fine quantization process to produce the fine energy 122. The number of bits used for the fine quantization bits is determined by the total number of energy-assigned bits minus the number of bits used for the coarse quantization process. When added together, the coarse energy 120 and the fine energy 122 represent a total quantized value of the energy level 116, which may be represented, as one example, by 14 bits in a fixed-point signed representation.

The audio encoder 24A may be further configured to encode the coarse energy 120, the fine energy 122, and the residual ID 124 using a bitstream encoder 110 to create the encoded audio data 25. The bitstream encoder 110 may be configured to further compress the coarse energy 120, the fine energy 122, and the residual ID 124 using one or more entropy encoding techniques. Entropy encoding techniques may include Huffman coding, arithmetic coding, context-adaptive binary arithmetic coding (CABAC), and other similar entropy encoding algorithms. The encoded audio data 25 may then be transmitted to the sink device 14 and/or stored in a memory for later use.

In one example, the quantization performed by the energy quantizer 106 is a uniform quantization. That is, the step sizes (also called “resolution”) of each quantization are equal. In some examples, the step sizes may be in units of decibels (dBs). The step size for the coarse quantization and the fine quantization may be determined, respectively, from a predetermined range of energy values for the quantization and the number of bits allocated for the quantization. In one example, the energy quantizer 106 performs uniform quantization for both coarse quantization (e.g., to produce the coarse energy 120) and fine quantization (e.g., to produce the fine energy 122).

Performing a two-step, uniform quantization process is equivalent to performing a single uniform quantization process. However, by splitting the uniform quantization into two parts, the bits allocated to coarse quantization and fine quantization may be independently controlled. This may allow for more flexibility in the allocation of bits across energy and vector quantization and may improve compression efficiency.

Consider an M-level uniform quantizer, where M defines the number of levels (e.g., in dB) into which the energy level may be divided. M may be determined by the number of bits allocated for the quantization. For example, the energy quantizer 106 may use M1 levels for coarse quantization and M2 levels for fine quantization. This equivalent to a single uniform quantizer using M1*M2 levels.

FIG. 2B is a block diagram illustrating an example audio encoder that performs various aspects of the MS-PVQ normalization techniques described in this disclosure. In the example of FIG. 2B, an audio encoder 24B may represent another example of the audio encoder 24 shown in the example of FIG. 1 and may perform PVQ in a similar manner to that of the audio encoder 24A shown in the example of FIG. 2A. Similar to the audio encoder 24A, the audio encoder 24B may include the transform unit 100, the subband filter 102, the gain-shape analysis unit 104, the energy quantizer 106, the vector quantizer 108, and the bitstream encoder 110.

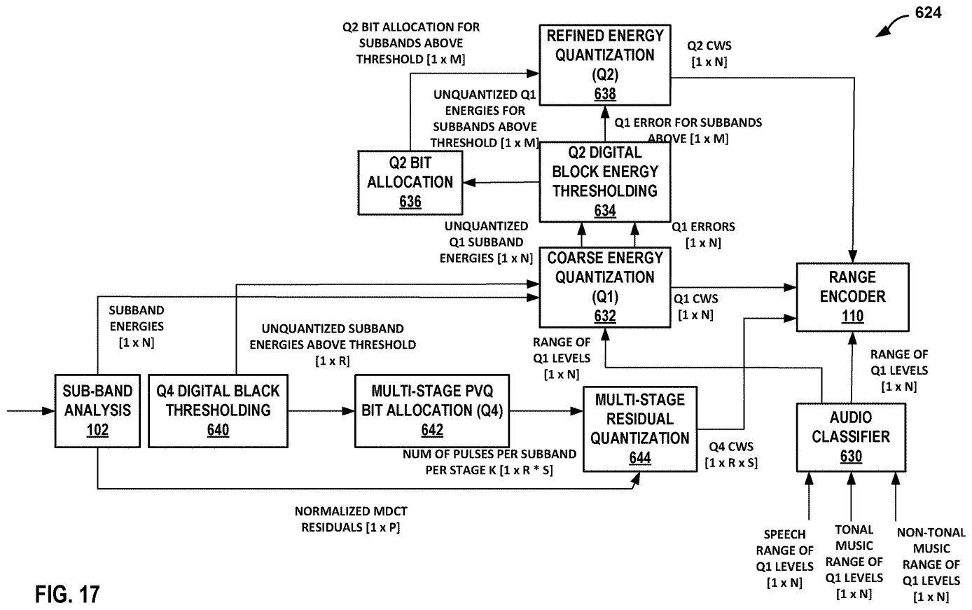

However, the vector quantizer 108 may perform a multi-stage PVQ or other vector quantization process, as described in more detail with respect to the example shown in FIG. 17. In addition, the subband processing unit 128 may include a normalization unit 121 (“norm 121”) in which residual values are normalized via an L2 normalization process (“L2 norm”) or some other normalization process that produces normalized residual values using more than 10 bits (e.g., 14) in a fixed-point unsigned representation. The vector quantizer 108 may compute the error between the selected vector from the V-table and the audio data to obtain the residual values per each subband, which are provided back to the vector quantizer 108 for subsequent stages of the vector quantization. The vector quantizer 108 may, after each stage, output residual IDs 124 to the bitstream encoder 110, which may encode the residual IDs 124 as the encoded audio data 25 (possibly using stacked codewords and potentially avoiding local minima as discussed in more detail throughout this disclosure).

In other words, the core to the multi-stage PVQ (MS-PVQ) is the addition of a loop with a normalization (shown as “norm 121”). Gain-shape residual vectors 118 are input to the MS-PVQ core represented by vector quantizer 108, quantized and encoded by the PVQ and pushed into the bitstream represented by the encoded audio data 25. Norm 121 may normalize the error associated with the quantized residual to standardize the energy level and maximize the dynamic range, before passing through another iteration or stage of the MS-PVQ, where the vector quantizer 108 may quantize and encode before being inserted into the bitstream 31. Norm 121 may perform normalization relative to the L2-norm of unquantized residual error, where the raw normalization level should be quantized to minimize the number of bitstream encoded bits required.

In some instances, norm 121 may predict the next stage normalization based on past stage quantized residual characteristics and may use normalization gains to more optimally minimize the number of bitstream encoded bits required. The vector quantizer 108 may end MS-PVQ residual quantization when either the target number of iterations is reached or when the residual error is less than or equal to target minimum gain levels (or, in other words a target threshold gain level). More information regarding the MS-PVQ process is described below with respect to the example of FIG. 17.

FIG. 17 is a block diagram illustrating an example multi-stage pyramid vector quantization (MS-PVQ) performed by the vector quantizer in accordance with various aspects of the techniques described in this disclosure. In the example of FIG. 17, an audio encoder 624 is shown, which may represent one example of the audio encoder 24B. The audio encoder 624 includes a subband analysis 102 (which is another way to refer to the subband filter 102 in combination with the gain-shape analysis unit 104), a range encoder 110 (which is another way to refer to the bitstream encoder 110), an audio classifier 630, a coarse energy quantization (Q1) unit 632, a Q2 digital block energy thresholding unit 634, a Q2 bit allocation unit 636, a refined (or fine) energy quantization unit 638, a Q4 digital block thresholding unit 640, a multi-stage bit allocation (Q4) unit 642, and a multi-stage residual quantization unit 644.

The audio classifier 630 may identify a type of the audio data 21 (or frequency domain audio data 112), where the type of the audio data 21 may include one of a speech type, a tonal music type, and a non-tonal music type. The audio classifier 630 may, based on the type of the audio data 21, output a range of the Q1 levels (which may be 1×N). The audio classifier 630 may provide the range of Q1 levels to the coarse energy quantization unit 632.

The coarse energy quantization unit 632 may perform coarse energy quantization with respect to the energy level 116 (shown in the example of FIG. 2B) as described above, outputting unquantized Q1 subband energies and Q1 error (which is another way to refer to energy quantization residuals) to Q2 digital block energy thresholding unit 634. The Q2 digital block energy thresholding unit 634 may perform thresholding, comparing the unquantized Q1 subband energies to an energy threshold. When the unquantized Q1 subband energies are less than the energy threshold, the Q2 digital block energy thresholding unit 634 may remove the subband energy from the unquantized Q1 subband energies. When the unquantized Q1 subband energies are greater than the energy threshold, the Q2 digital block energy threshold may output the corresponding Q1 error for the subbands, while also outputting the unquantized Q1 energies for subbands above the energy threshold to the Q2 bit allocation unit 636.

The Q2 bit allocation unit 636 may determine a bit allocation for each subband remaining after the digital block energy thresholding performed by the Q2 digital block energy thresholding unit 634. The Q2 bit allocation unit 636 may allocate more bits to the Q1 energies for subbands having a higher energy and relatively less bits to the Q1 energies for subbands having less energy. The Q2 bit allocation unit 636 may output the bit allocation for subbands above the energy threshold to refined energy quantization unit 638, which may perform fine quantization with respect to the Q1 error for subbands above the energy threshold. The Q2 bit allocation unit 636 may output a Q2 codeword (CW) to the range encoder 110.

The coarse energy quantization unit 632 may also output the unquantized subbands energies above the energy threshold to Q4 digital black thresholding unit 640, which may apply another energy threshold to the unquantized subbands energies to obtain unquantized subband energies above the second (or another) energy threshold.

The Q4 digital block thresholding unit 640 may output unquantized subband energies above this second (or another) energy threshold to the multi-stage PVQ bit allocation unit 642, removing any unquantized subband energies below or equal to the second energy threshold. The multi-stage PVQ bit allocation unit 642 may identify a number of pulses per subband per stage (denoted by variable ‘K’), resulting in a vector of 1×R*S. The multi-stage residual quantization unit 644 may perform PVQ with respect to the normalized MDCT residuals (of size 1×P, where P denotes the number of pulses) to obtain the Q4 codewords (CWs). The multi-stage residual quantization unit 644 may output the Q4 CWs to range encoder 110, which may specify the Q4 CWs in the audio bitstream 31.

In other words, various aspects of the techniques described in this disclosure enable the audio encoder 624 to provide a multi-staged residual value encoder that may possibly encode very efficiently to high accuracies while keeping both encoding table sizes (e.g., V-tables) and complexity low. The audio encoder 624 may achieve the low memory and complexity by recursively applying an error coding scheme, where the individual iteration of the encoding may remain small, which limits the complexity and table size required. Applying multiple stages and re-normalization between each iteration may achieve a higher accuracy, but may also possibly remove the memory and complex limitation of existing gain-shape audio codecs where a single scheme would be prohibitive.

Various aspects of the multi-stage vector quantization techniques may provide a 40 decibel (dB) in the THD+N metric with little to no increase in complexity or code size and has a comparable perceptual evaluation of audio quality (PEAQ) measurement with LC3 and/or LC3 Plus algorithms. The scheme discussed in this disclosure may provide a more targeted allocation of bits which may more closely mirror the energy spectrum and does not require additional bits as the bit pool has not increased, possibly even for very narrow band signal where existing single stage coded may perform poorly.

As such, the audio encoder 624 may only encode the selected subbands (meaning bands with energy below a given energy threshold are encoded). The audio encoder 624 may allocate bits for each subband multiple times in comparison to the constraints of a single stage of PVQ, possibly limiting the N PVQ stages where the maximum bit allocation is now N*maximum PVQ bits per subband. As a result, the audio encoder 624 may provide much higher accuracy (compared to the single stage PVQ) because of the multi-stage nature of the MS-PVQ.

The audio encoder 624 may also switch, based on the audio type, the Q1 energy quantization to accommodate for tone types, music tonal types, or non-music tonal types. The audio encoder 624 may also allocate Q2 bits in response to the Q1 unquantized energy. Given this bit allocation scheme, the audio encoder 624 may better focus bit allocations to subbands where such bits are possibly most needed because energy and PVQ residual quantizations can now scale to higher bit allocations with potentially manageable impact on memory and central processing unit (CPU) complexity.

Q1 had one pre-defined V-table in a single-stage vector quantization scheme discussed above, where the MS-PVQ allows for selecting multiple V-tables depending on audio classification. For example, the range of the vectors in the V-table may be expanded to better match the required high dynamic range for tonal audio where the audio classification used for each frame may be encoded in the audio bitstream 31.

Q2 bits may be used for fine energy envelop quantification, which may be modified to be dynamic to keep up with the MS-PVQ encoding accuracy gains. Such modifications may allow for more freedom to push bits to subbands that possible require extra bits, while the digital block threshold may be used to remove bands that have a low energy.

The MDCT subband energy envelop is coarsely quantized and the unquantized subband energies of that quantization process are classified using energy thresholding. In this instance, the audio encoder 624 may remove subbands with energy below the energy threshold and may not quantize or encode those subbands (e.g., the subbands are set to digital block, which may be equal to zero). The audio encoder 624 may then redistribute all allocated bits (e.g., from subbands set to digital block) to portions of the MDCT spectrum with energy above the energy threshold. The coarse unquantized energy magnitudes are also used to dynamically allocate bits for additional Q2 fine quantization of the subband envelop in subbands that have energy levels above the target energy threshold. This may target bits to high energy subbands (relative to the energy threshold) envelop quantization and encoding. The MS-PVQ quantizes and encodes the active subband residuals (e.g., with energy above the energy threshold) using multiple stages or iterations of the MS-PVQ stage, which may be defined per stage bit allocations output of the Q4 residual bit allocation algorithm.

The bit allocation in the single-stage PVQ (shown, for example, in FIG. 2A) may allocate bits to subbands based on the relative amount of energy in each active subband, which may be translated into PVQ pulses based on a known relationship between bits allocated, PVQ pulses, and number of bins in a subband. The Q4 residual bit allocation algorithm (implemented by multi-stage PVQ bit allocation unit 642) may additionally divide the energy-based bit allocation per subband across PVQ stages. The MS-PVQ (implemented by multi-stage residual quantization unit 644) may generate a CW size of 52-bits per PVQ stage because the tables may be small enough to fit the embedded processors memory structure but still may provide sufficient (and/or good) accuracy.

The multi-stage residual quantization unit 644 may limit additional PVQ pulses in subbands with less than a threshold number of bins (e.g., 6 bins) to cap the table size and processing cycle complexity to an acceptable level. The number of MS-PVQ stages is calculated by bits allocated to the subband divided by the maximum CW size for each remaining subband in bits (e.g., 52 bits). The multi-stage residual quantization unit 644 may obtain the total number of bits for the subband for each stage equally over the PVQ stages. The sum of all bit allocations to each stage in an individual subband of the residual quantization unit 644 (which is another way of referring to the multi-stage residual quantization unit 644) can be large but does not increase overall complexity because the allocators are done in discrete resource constrained stages and more stages in one band may result in less or no bits allocated to another subband.

In this way, various aspects of the multi-stage vector quantization techniques may improve THD+N for narrow band signals where bits can be dynamically allocated where energy is the highest. The audio encoder 624 may effectively marry energy classification algorithms like thresholding to solve poor THD+N problems. Subbands with very low energy levels can be effectively ignored and the encoding bits reallocated to those parts of the spectrum which have more energy, which proves to be possibly effective at low bit rates as it allows a much more effective distribution of the bit allocation. For narrow band audio most of the bit allocation may be constrained into a small number of bands. The multi-stage nature of the multi-stage PVQ allows for many stages and may possibly target the accuracy where it is needed to achieve a good decode reconstruction compared to single stage PVQ (and/or other single stage vector quantization algorithms).

Wider subbands increase the PVQ dimensionality, and the encoding enumeration algorithm tables (e.g., the V-tables) scale exponentially with this as encoding an N dimension PVQ requires an Nth order polynomial. Increases in the PVQ range will increase the table approximately exponentially. Various aspect of the multi-stage vector quantization techniques described in this disclosure may enable the codec to focus bitstream data on important subbands and may improve sinusoidal tone coding errors.

As noted above, the audio encoder 624 may promote noise reduction (THD+N) and scale to much higher bitrates as the multi-stage PVQ may circumvent processor resource usage limits. Increasing the accuracy of the single-stage PVQ may result in increasing the pulses count used. To enumerate a CW for a large pulse count may involve large memory tables or high processing cycle cost, where a similar problem would also be encountered when decoding a CW into a shape. The multi-stage PVQ techniques described in this disclosure may reduce CW enumeration encoding complexity and may scale dynamically to desired bitrates (through expanding or contracting the number of stages) without possible necessitating unmanageable encoding table sizes or processing complexity.

Further, various aspects of the multi-stage PVQ techniques may include an inter-stage re-normalization of the residual error terms and thereby allow for each PVQ stage to reduce the decoded reconstruction errors by decreasing the vector lattice pulse separation distance. As such, the multi-stage PVQ techniques may allow for dynamic scaling, which may allow the allocation of bits to closely mirror the energy spectrum of the signal. The codec (e.g., the audio encoder 624 and/or the audio decoder 44) may increase subband sizes at the higher frequences of higher sampling rates, for instance when encoding 192K audio at 100 Kbps to transport over a PAN link, but continue to possibly dynamically respond to higher energies in those bands and target bitrate allocations to those higher energy subbands.

Additionally, the MS-PVQ techniques may allow for a 40 dB improvement in THD+N with very little code size given that there is only extra code for the digital block thresholding and the normalization provided between stages of the PVQ where no extra tables are required. The processing complexity is predicted to be much lower than comparable codecs given no extra processing complexity as the processing complexity scales with the number of interactions with the PVQ, and the MS-PVQ algorithm is low in complexity because it uses memory constrained look-up tables (e.g., V-tables). The MS-PVQ techniques may remove bitrate restrictions allowing the codec to focus bit allocation on highest energy levels within a frame, where the only limit on decoded audio accuracy imposed by the multi-stage PVQ is the numerical accuracy of the processor on which the MS-PVQ algorithm is executed.

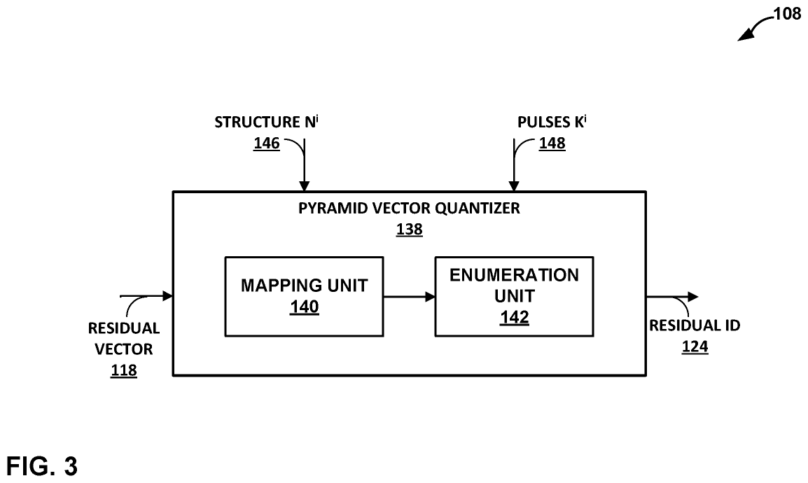

FIG. 3 is a block diagram illustrating an example vector quantizer 108 configured to perform various aspects of the techniques described in this disclosure. In particular, the vector quantizer 108 may include a pyramid vector quantizer 138 that is configured to perform pyramid vector quantization (PVQ) of residual vectors of audio data.

The residual vector 118 is input to the pyramid vector quantizer 138. As discussed above, the residual vector 118 is a residual vector of one of subbands 114 of frequency domain audio data. In operation, the pyramid vector quantizer 138 generates a residual ID 124 to encode the residual vector 118. As the residual vector 118 is a residual vector of one of subbands 114, the pyramid vector quantizer 138 may generate a separate residual ID 124 for each of the subbands 114 or vector quantizer 108 may include a separate pyramid vector quantizer 138 for each of the subbands 114. The assignment of residual IDs to the codevectors on the hypersurface may be a lossless process.

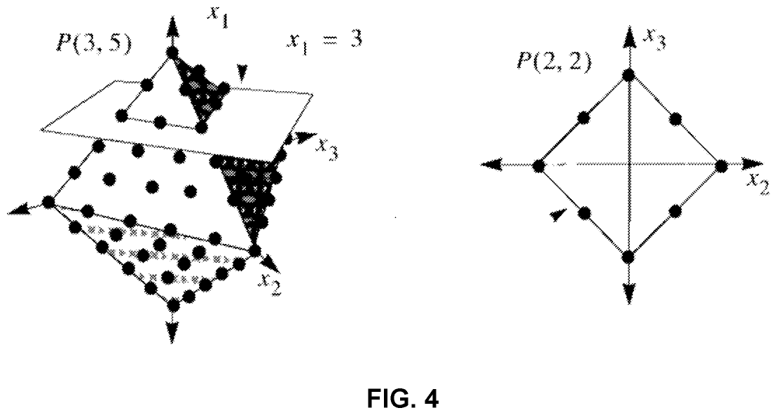

As shown in FIG. 3, the pyramid vector quantizer 138 includes a mapping unit 140 and an enumeration unit 142. To perform PVQ, the mapping unit 140 may map the residual vector 118 onto an N-dimensional hypersurface (e.g., a hyperpyramid) and the enumeration unit 142 may assign a unique identifier (ID) to each codevector on the hypersurface. The mapping of a residual vector may be parameterized by a structure N 146 and pulses K 148. The structure N 146 may represent the number of samples in the residual vector to be quantized (i.e., the number of samples in residual vector 118) and the pulses K 148 may represent the number of pulses to be included on the N-dimensional hypersurface. FIG. 4 is a conceptual diagram that illustrates an example hyperpyramid used for performing pyramid vector quantization. In the example of FIG. 4, the hyperpyramid had an N of 3 and a K of 5.

The level of quantization of the residual vector 118, and thus the loss, is dependent on the number of pulses K 148 used for the subband. The number of pulses K 148 used for a subband is dependent on the number of bits allocated to encoding the residual vector in the subband. Subbands that are allocated higher numbers of bits may be encoded using more pulses, which may result in less distortion (i.e., loss) than subbands that are allocated lower numbers of bits.

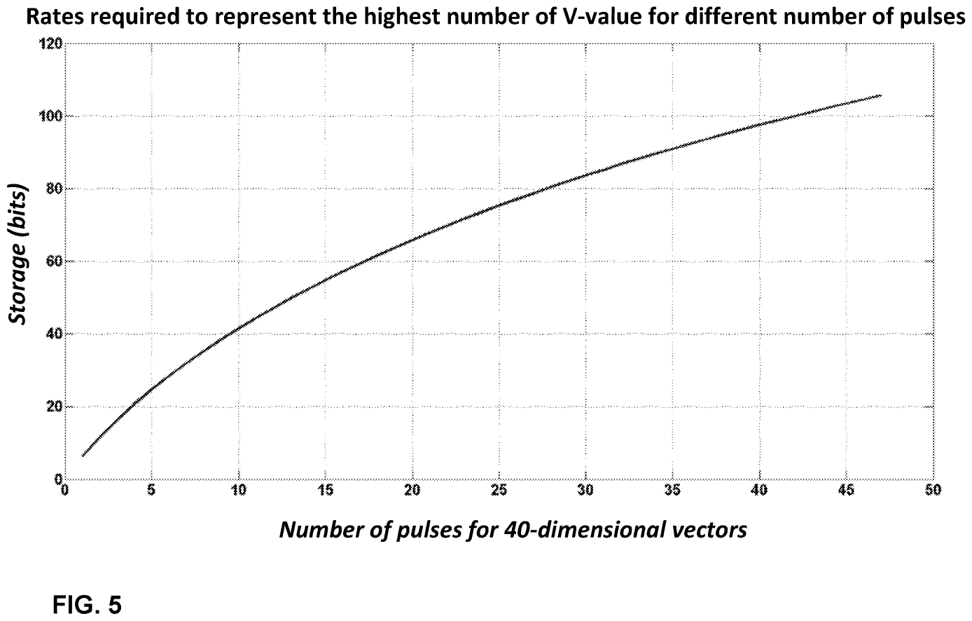

FIG. 5 is a graph illustrating the amount of storage required to explicitly store V-vectors as a function of pulses. Specifically, FIG. 5 shows the storage requirements of V-vectors for performing PVQ with different pulse counts and an N of 40 (i.e., 40 dimensional residual vectors). As discussed above, the V-vectors used to perform PVQ may require a large amount of table memory. For example, explicit storage of V-values for 28 subbands may require ~11,302 kB. Larger values of N (i.e., higher dimensions) cause the storage requirements to grow very quickly.

Storing the entire table entries may not be feasible either. For example, memory requirements cannot be fulfilled for large scale implementations. However, in accordance with one or more techniques of this disclosure, existing redundancy when the tables are used for several subbands can be exploited to reduce the storage requirements significantly. Additionally, permutations without replacements can be used to reduce memory with up to one bit for each entry. Symmetry of the resulting table may provide further room for memory savings which leads to U representation.

Further compressions utilizing relationships among different vectors of different representations can further reduce the size of stored data.

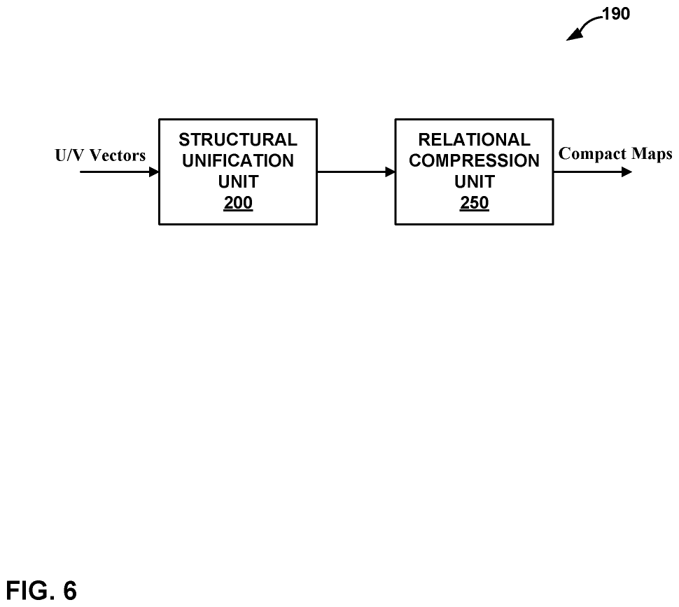

FIG. 6 is a block diagram illustrating an example compact map generation unit 190, in accordance with one or more techniques of this disclosure. The compact map generation unit 190 may be included in one or both of source device 12 and sink device 14. In some examples, the compact map generation unit 190 may be included in a device other than source device 12 and sink device 14 and may provide the generated compact maps to one or both of source device 12 and sink device 14.

As shown in FIG. 6, the compact map generation unit 190 includes a structural unification unit 200 and a relational compression unit 250. Together, the structural unification unit 200 and the relational compression unit 250 perform structural unification and relational compression to generate an enumeration map and unique ID that corresponds to a bit value of one or more audio samples. Structural unification and relational compression are equivalent to direct or inverse PVQ enumeration (e.g., as performed by the enumeration unit 142).

U or V-Vectors are input to the structural unification unit 200, which performs structural unification to generate a plurality of unified vectors. As different numbers of coefficients will point to different V-values with different dimensions, hashing can be used to represent data (e.g., by defining nₘ's as keys and V_{n,k}'s of all possible pulses as values). A unique representation of n

$${n}_{u} = {[ {n}_{i} ]}_{I \times 1}$$

Where I≤M, keys are

$${\{ {n}_{i} \}}_{i = 1}^{I} ,$$

pointing to values

$${\{ {v}_{i} \}}_{i = 1}^{I}$$

defined as

$${v}_{i} = {⌊ {V}_{{n}_{i} , k} ⌋}_{{K}_{i \times 1}}$$

$$where {K}_{i} = {max}_{i} \{ {k}_{i} \}$$

$$V ( {n}_{i} , {K}_{i} ) \leq {2}^{{B}_{i , max}}$$

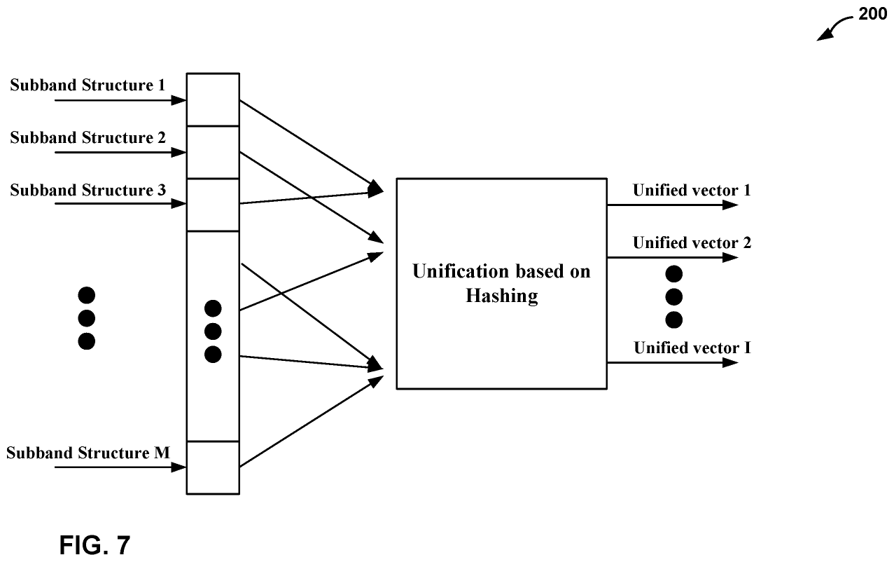

As such, the structural unification unit 200 may map multiple subbands to one unified vector (that is the value of the hash). By generating the unified vectors from all of the different subbands, the audio encoder may remove redundancy between the subbands. For instance, as shown in FIG. 7, the structural unification unit 200 may perform hashing to generate I unified vectors from M subbands. As one example, the structural unification unit 200 may perform hashing to generate 6 or 7 unified vectors from 28 subbands.

V is the original V function that does the enumeration. V determines total number of quantization points, once N and K are established, and it may become a recursive function such that every single time that you have the U vector you have to go through the recursion.

U function is another representation of V, the difference is that it requires less bits for each cell, as a result of the matrix being symmetric. To generate the U-Vectors, the compact map generation unit 190 may perform a permutation by replacement, so total number of possible selections once the number of pulses is known is one less, requires a lot less memory, is one order of bits less memory required, not readily transferable to getting a unique id, but the U representation step which is quantization.

To generate the U-representation, for any V-table the compact map generation unit 190 may find a symmetric U-table such that

$$U ( N , K ) + U ( N , K + 1 ) = V ( N , K )$$

$$N \geq 0 and K \geq 0$$

As stated above, the U-representation information content is at most approximately one bit less than that of V-values in a V-representation, in average

$$U ( N , K ) \leq V ( N , K ) \leq 2 U ( N , K + 1 )$$

$${log}_{2} ( U ( N , K ) ) \leq {log}_{2} ( V ( N , K ) ) \leq 1 + {log}_{2} ( U ( N , K + 1 ) )$$

Another storage saving is provided by U-representation due to its symmetry

$$U ( N , K ) = U ( K , N )$$

However, use of the U-representation comes with extra computations, due to one more recall and addition per ID. U-representation can save storage as a form of representation of data, but cannot provide unique IDs directly. Equivalent V-values are eventually used for transmission to the decoder.

The structural unification may be effective because some similarities may exist between subbands. As such, the structural unification unit 200 may look at all subbands and look at all similarities so it can unify the subbands so that they would be similar in terms of U and V vectors, multiple subbands can be mapped to one unified vector (that may be the value of the hash).

The following table provides example memory requirements in kB for a V-representation, U-representation, and the developed subbanding-based unified implementation of the adaptive PVQ. As can be seen, the developed unified approach (in accordance with this disclosure) based on the subbanding in this mode offers significant reduction in memory. It is over 97% and 90% more memory efficient than V- and U-representations, respectively.

| | V- | U- | Developed |
|---|---|---|---|
| Realization | representation | representation | unified |
| Memory (kB) | 11.3 | 2.97 | 0.29 |

The output of the structural unification unit 200 (i.e., the unified vectors) may be provided as input to the relational compression unit 250. The relational compression unit 250 may perform inter-vector or intra-vector compression on the unified vectors. This may result in additional storage savings over just using the unified vectors.

To perform inter-vector compression, the audio encoder may assume a base vector and formulate the remaining vectors as functions of the base vector. As such, the audio encoder may only have to store the following (which may be less than the storage required for the uncompressed vectors):

$$\{ \{ [ {m}_{ib , nz}^{T} , {r}_{ib , nz} ] , i = \{ 1 , … , M \} - \{ b \} \} , {v}_{b} \}$$

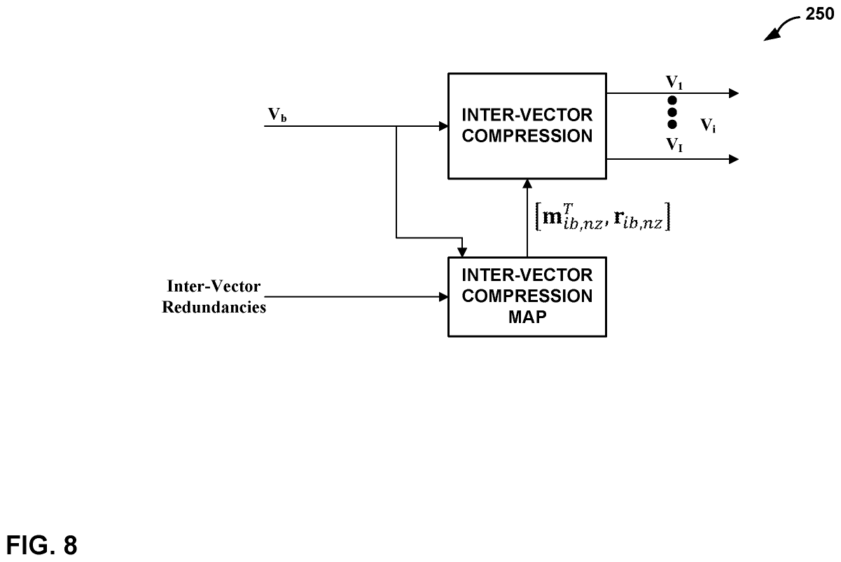

FIG. 8 is a block diagram illustrating an example relational compression unit 250 that may perform inter-vector compression, in accordance with one or more techniques of this disclosure. As shown in FIG. 8, the relational compression unit 250 may obtain a base vector V_{b} and output inter compressed vectors Vᵢ. Considering inter-vector redundancies, data can be compressed by assuming the base vector and formulating the remaining vectors as functions of the base. Each non-base vector may be represented as:

$${v}_{i} = {m}_{ib}^{T} {v}_{b} + {r}_{ib} for all i \neq b$$

Then the storage set

$$\{ \{ [ {m}_{ib , nz}^{T} , {r}_{ib , nz} ] , i = \{ 1 , … , M \} - \{ b \} \} , {v}_{b} \}$$

In some examples, the relational compression unit 250 may only store non-zero values. Therefore:

$$\vert {m}_{ib , nz} \vert \leq \vert {m}_{ib} \vert and \vert {r}_{ib , nz} \vert \leq \vert {r}_{ib} \vert$$

To perform intra-vector compression, the relational compression unit 250 may store difference values. For instance, as opposed to storing {V₁, V₂, and V₃}, the relational compression unit 250 may store{V₁, ΔV₁, and ΔV₂} where V₂=ΔV₁+V₁ and V₃=ΔV₂+V₂, which is be less than the storage required for the uncompressed vectors.

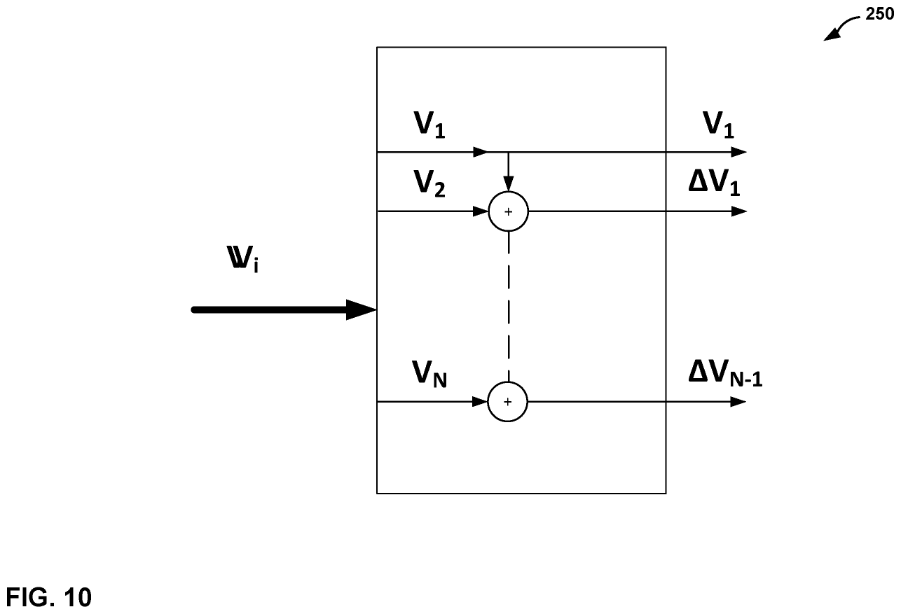

FIG. 10 is a block diagram illustrating an example relational compression unit 250 that may perform intra-vector compression, in accordance with one or more techniques of this disclosure. As shown in FIG. 10, the relational compression unit 250 may obtain inter compressed vectors V₁ and output intra compressed vectors. As discussed above, instead of storing explicit values, difference vectors can be considered.

$$\{ {V}_{1} , {V}_{2} , … {V}_{n} , … {V}_{N} \}$$

$$\{ {V}_{1} , Δ {V}_{1} , … Δ {V}_{n - 1} , … Δ {V}_{N - 1} \}$$

In which Vₙ=Vₙ₋₁+ΔVₙ₋₁

As such, if the expected value of the storage required is:

$${S}_{V} = \frac{1}{N} {\sum }_{n = 1}^{N} {S}_{{V}_{n}}$$

$$And$$

$${S}_{Δ V} = \frac{1}{N - 1} {\sum }_{n = 1}^{N - 1} {S}_{Δ {V}_{n}}$$

The total memory savings

$$Δ S = ( N \cdot {S}_{V} ) - ( {S}_{{V}_{1}} + ( N - 1 ) \cdot {S}_{Δ V} ) = ( {S}_{{V}_{1}} + \frac{N}{N - 1} {\sum }_{n = 2}^{N} {S}_{V n} ) - ( {S}_{{V}_{1}} + ( N - 1 ) \cdot {S}_{Δ V} ) = \frac{N}{N - 1} {\sum }_{n = 2}^{N} {S}_{V n} - ( N - 1 ) {S}_{Δ V}$$

Then, as N grows

$${lim}_{N \to ∞} Δ S = ( N - 1 ) \cdot {S}_{V} - ( N - 1 ) \cdot {S}_{Δ V} = ( N - 1 ) ( {S}_{V} - {S}_{Δ V} )$$

$$\overline{Δ S} = {lim}_{N \to ∞} \frac{1}{N} Δ S = {S}_{V} - {S}_{Δ V}$$

As such, storage savings may be ensured.

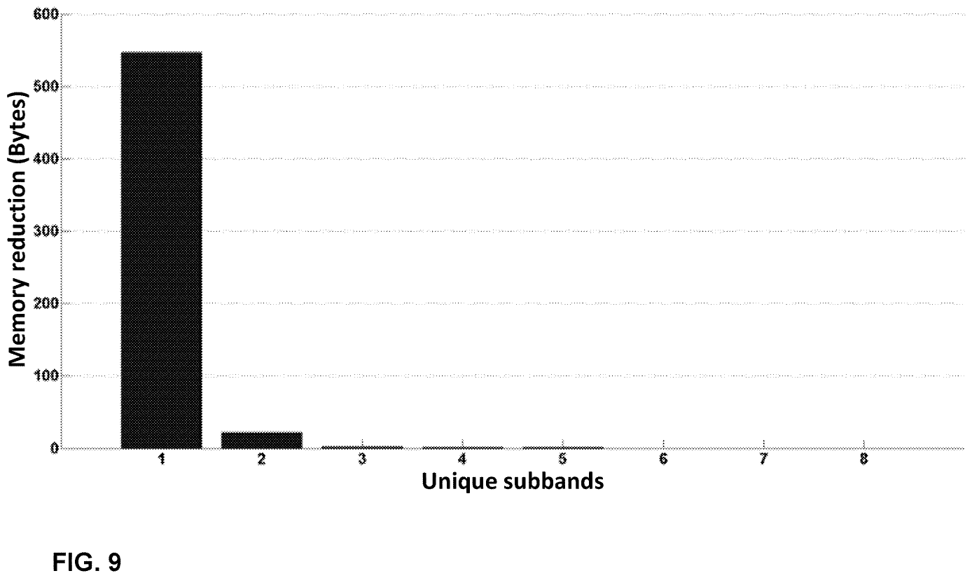

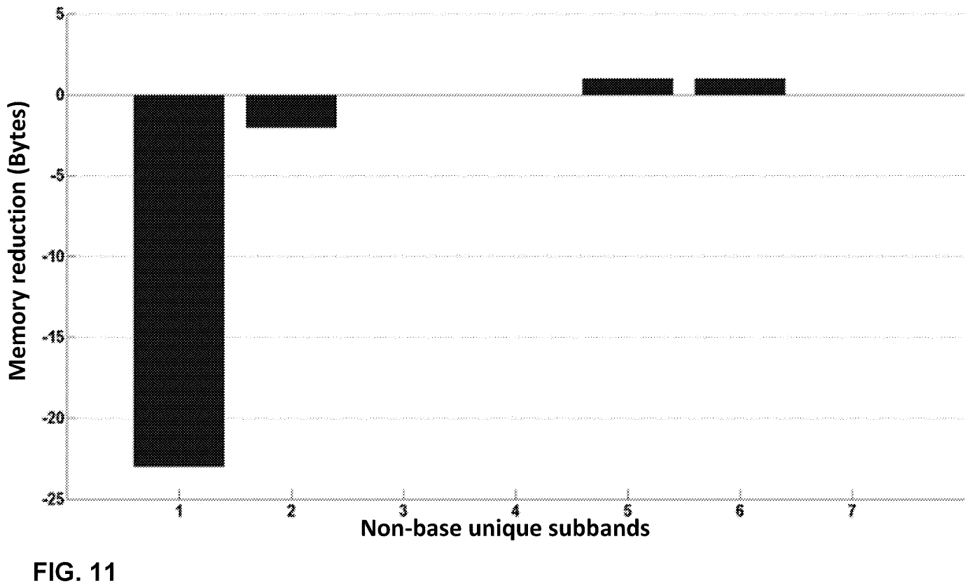

FIG. 9 is a graph illustrating example memory reductions on unique subbands using inter-vector compression, in accordance with one or more techniques of this disclosure. FIG. 11 is a graph illustrating example memory reductions on unique subbands using intra-vector compression, in accordance with one or more techniques of this disclosure. As can be seen from FIG. 9 and FIG. 11, inter-vector redundancies are more advantageous in lower subbands in contrast to intra-vector redundancies in higher subbands. As a result, differentiations in lower subbands, versus linear mappings in higher subbands may be advantageous.

The subbanding-based unification, and relational compression rules for inter-vector and intra-vector redundancies lead to lossless compression, reduced computations and storage saving may be achieved.

As an example problem-specific realization, up to 90% reduction in storage and no performance loss were achieved within a dynamic bit allocation in audio transform domain for an example MDCT-based implementation. In a lower compression encoder, residual quantization processing performance was reduced by ~₆₄% (from 17.00 MIPS (Millions of instructions per second) down to 6.16 MIPS on Qualcomm® Kalimba™ DSP (Digital Signal Processor)).

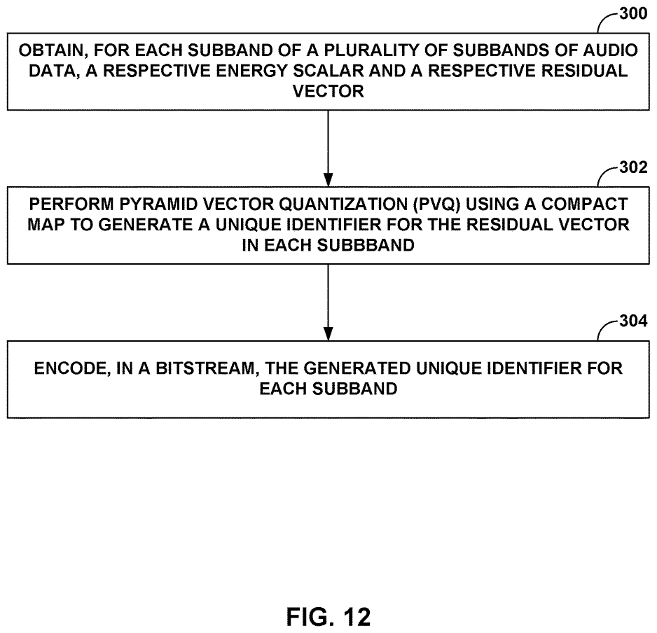

FIG. 12 is a flowchart illustrating example operation of the source device 12 of FIG. 1 in performing various aspects of the techniques described in this disclosure. As shown in the example of FIG. 12, the audio encoder 24 of the source device 12 may be configured to encode audio data using compact maps in accordance with the techniques of this disclosure.

The audio encoder 24 may be configured to obtain, for each subband of a plurality of subbands of audio data, a respective energy scalar and a respective residual vector (300). For instance, gain-shape analysis unit 104 of audio encoder 24 may generate, for each of subbands 114, a respective energy level 116 and a respective residual vector 118.

The audio encoder 24 may be further configured to perform pyramid vector quantization (PVQ) using a compact map to generate a unique identifier for the residual vector in each subband (302). For instance, the vector quantizer 108 may use a compact map generated using structural unification of vectors across subbands and relational compression to generate a residual ID 124 for each subband. By using the compact map, the vector quantizer 108 may avoid having to explicitly store all of the possible codevectors that may be used by various combinations of N and K.

The audio encoder 24 may encode, in an encoded audio bitstream, the generated unique identifier for each subband (304). For instance, the audio encoder 24 may encode each of residual IDs 124 in the encoded audio bitstream 31 which is transmitted to the sink device 14 over the transmission channel.

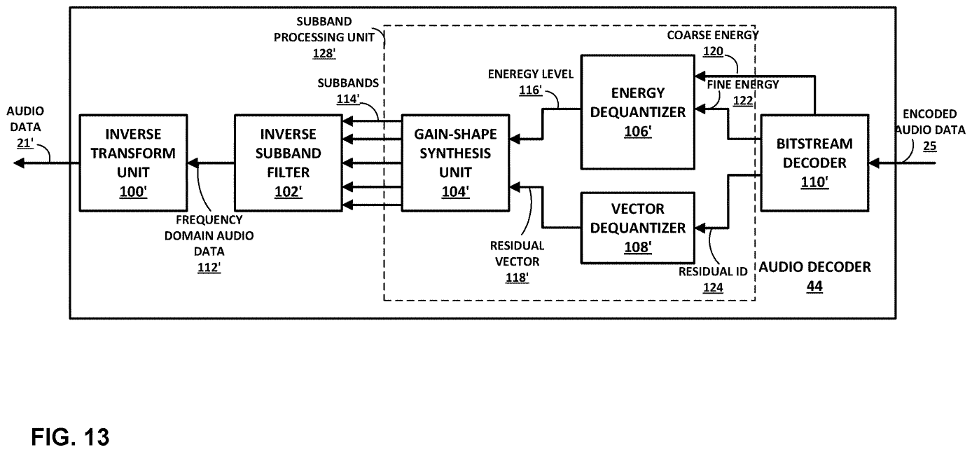

FIG. 13 is a block diagram illustrating an implementation of the audio decoder 44 of FIG. 1 in more detail. The audio decoder 44 may be configured to decode audio data received over a PAN (e.g., Bluetooth®). However, the techniques of this disclosure performed by the audio decoder 44 may be used in any context where the compression of audio data is desired. In some examples, the audio decoder 44 may be configured to decode the audio data 21′ in accordance with as aptX™ audio codec, including, e.g., enhanced aptX—E-aptX, aptX live, and aptX high definition. However, the techniques of this disclosure may be used in any audio codec configured to perform cooperative pyramid vector quantization (PVQ) of audio data. As will be explained in more detail below, the audio decoder 44 may be configured to perform a PVQ process using compact maps and/or normalized residual values as described above.

In general, audio decoder 44 may operate in a reciprocal manner with respect to audio encoder 24. As such, the same process used in the encoder for quality/bitrate scalable cooperative PVQ can be used in the audio decoder 44. The decoding is based on the same principles, with inverse of the operations conducted in the decoder, so that audio data can be reconstructed from the encoded bitstream received from the audio encoder 24 (although normalization cannot be inversed, and as such reconstruction, including MS-PVQ, may be performed with respect to the normalized residual data). Each quantizer has an associated dequantizater counterpart. For example, as shown in FIG. 13, inverse transform unit 100′, inverse subband filter 102′, gain-shape synthesis unit 104′, energy dequantizer 106′, vector dequantizer 108′, and bitstream decoder 110′ may be respectively configured to perform inverse operations with respect to transform unit 100, subband filter 102, gain-shape analysis unit 104, energy quantizer 106, vector quantizer 108, and bitstream encoder 110 of FIG. 2A or 2B.

In particular, the bitstream decoder 110′ may obtain, from the encoded audio data 25, a bit allocation, which the bitstream decoder 110′ may use to parse the encoded audio data 25 to obtain the normalized residual values (which may involve decoding stacked codewords to obtain singular codewords for each vector, e.g., in the form of individual residual IDs 124 or multiple residual IDs 124 as the stacked codeword, which the vector dequantizer 108′ may decode). The gain-shape synthesis unit 104′ reconstructs the frequency domain audio data, having the reconstructed (and possibly normalized) residual vectors along with the reconstructed energy levels. The inverse subband filter 102′ and the inverse transform unit 100′ output the reconstructed audio data 21′. In examples where the encoding is lossless, the reconstructed audio data 21′ may perfectly match the audio data 21. In examples where the encoding is lossy, the reconstructed audio data 21′ may not perfectly match the audio data 21.

In this way, the audio decoder 44 represents a device configured to receive an encoded audio bitstream (e.g., encoded audio data 25); decode, from the encoded audio bitstream, a unique identifier for each of a plurality of subbands of audio data (e.g., bitstream decoder 110′ outputs residual ID 124); perform inverse pyramid vector quantization (PVQ) using a compact map to reconstruct a residual vector for each subband of the plurality of subbands of the audio data based on the unique identifier for the respective subband of the plurality of subbands of the audio data (e.g., vector dequantizer 108′ performs the inverse PVQ); and reconstruct, based on the residual vectors and energy scalars for each subband, the plurality of subbands of the audio data (e.g., gain-shape synthesis unit 104′ reconstructs the subbands 114′).

The audio decoder 44 may also represent a device configured to obtain, from the encoded audio bitstream 31 (or, in other words, the encoded audio data), normalized residual data as 10 or more (e.g., 14) bits using a fixed-point signed representation, perform inverse multi-stage vector quantization with respect to the normalized residual data to obtain one or more subbands 114′ representative of the audio data 21. The audio decoder 44 may reconstruct, based on the one or more subbands 114′, the audio data 21′ which the audio decoder 44 may render to obtain one or more speaker feeds. The audio decoder 44 may output, for playback via one or more of the speakers 48, the one or more speaker feeds.

As the audio decoder 44 may operate reciprocally to the audio encoder 24B, in this example, the audio decoder 44 may recursively perform each stage of the inverse multi-stage vector quantization with respect to the encoded audio data 25 to obtain the one or more subbands 114′ representative of the audio data 21′. The encoded audio data 25 may include, for each stage of the multi-stage vector quantization, normalized residual data that has been normalized to standardize energy prior to performing each successive stage of the multi-stage vector quantization (e.g., MS-PVQ). The normalized residual data may, as noted above, be normalized according to an L2 norm algorithm or some other normalization algorithm. The audio decoder 44 may perform, as one example, inverse MS-PVQ with respect to the encoded audio data 25 (e.g., the normalized residual data) to obtain the one or more subbands representative of the audio data 21.

The encoded audio data 25 may include, for a first stage of the multi-stage vector quantization, a coarse quantization value (Q1) for each of the one or more subbands and a fine quantization value (Q2) for each of the one or more subbands. The coarse quantization value may be selected based on a type of the audio data identified by the audio classifier 630 of the audio encoder 624 (shown in the example of FIG. 17). The type of the audio data may correspond to a different vector table used for performing MS-PVQ, and may be signaled (as a syntax element) in the encoded audio data 25 to enable the audio decoder 44 to select the appropriate vector table for use during inverse MS-PVQ. As such, the encoded audio data 25 includes a syntax element identifying the type of the audio data, where the audio decoder 44 is configured to perform the inverse MS-PVQ based on the syntax element to select the corresponding different vector table. As noted above, the fine quantization value may be allocated based on the coarse quantization value.

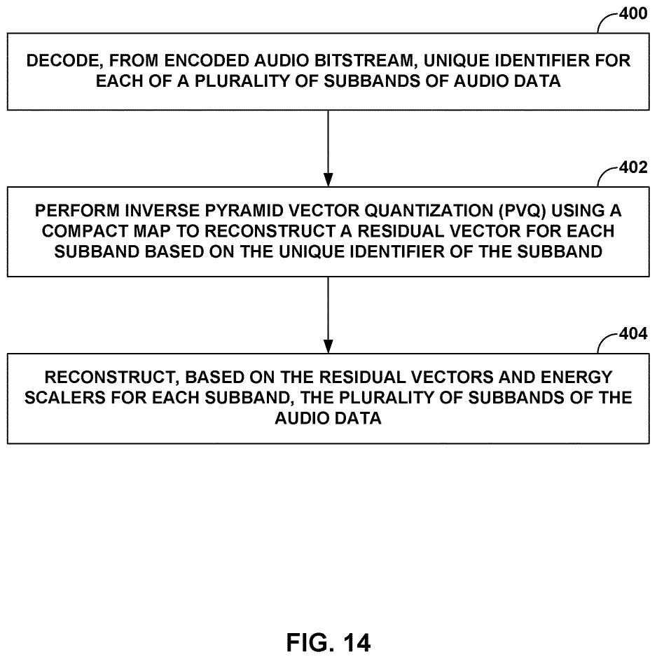

FIG. 14 is a flowchart illustrating example operation of the sink device 14 of FIG. 1 in performing various aspects of the techniques described in this disclosure. As shown in the example of FIG. 14, the audio decoder 44 of the sink device 14 may be configured to decode audio data using compact maps in accordance with the techniques of this disclosure.

The audio decoder 44 may be configured to decode, from an encoded audio bitstream, a unique identifier for each of a plurality of subbands of audio data (400). For instance, the audio decoder 44 may decode residual IDs 124 from the encoded audio bitstream 31.

The audio decoder 44 may perform inverse PVQ using a compact map to reconstruct a residual vector for each subband of the plurality of subbands of the audio data based on the unique identifier for the respective subband of the plurality of subbands of the audio data (402). For instance, the audio decoder 44 may use a compact map similar or identical to the one used by the audio encoder 24 to identify a codevector that corresponds to each of residual IDs 124. By using the compact map, the audio decoder 44 may avoid having to explicitly store all of the possible codevectors that may be used by various combinations of N and K.

The audio decoder 44 may reconstruct, based on the residual vectors and energy scalars for each subband, the plurality of subbands of the audio data (404). For instance, the audio decoder 44 may perform a process generally reciprocal to gain-shape analysis unit 104 to reconstruct that audio data using the identified codevectors and energy scalars decoded from the encoded audio bitstream.

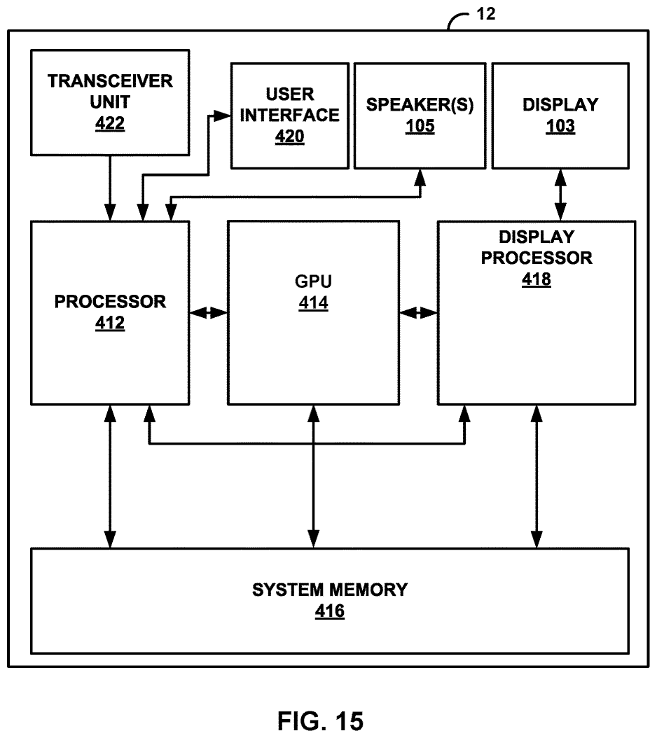

FIG. 15 is a block diagram illustrating example components of the source device 12 shown in the example of FIG. 1. In the example of FIG. 15, the source device 12 includes a processor 412, a graphics processing unit (GPU) 414, system memory 416, a display processor 418, one or more integrated speakers 105, a display 103, a user interface 420, and a transceiver unit 422. In examples where the source device 12 is a mobile device, the display processor 418 is a mobile display processor (MDP). In some examples, such as examples where the source device 12 is a mobile device, the processor 412, the GPU 414, and the display processor 418 may be formed as an integrated circuit (IC).

For example, the IC may be considered as a processing chip within a chip package and may be a system-on-chip (SoC). In some examples, two of the processors 412, the GPU 414, and the display processor 418 may be housed together in the same IC and the other in a different integrated circuit (i.e., different chip packages) or all three may be housed in different ICs or on the same IC. However, it may be possible that the processor 412, the GPU 414, and the display processor 418 are all housed in different integrated circuits in examples where the source device 12 is a mobile device.

Examples of the processor 412, the GPU 414, and the display processor 418 include, but are not limited to, one or more digital signal processors (DSPs), general purpose microprocessors, application specific integrated circuits (ASICs), field programmable logic arrays (FPGAs), or other equivalent integrated or discrete logic circuitry. The processor 412 may be the central processing unit (CPU) of the source device 12. In some examples, the GPU 414 may be specialized hardware that includes integrated and/or discrete logic circuitry that provides the GPU 414 with massive parallel processing capabilities suitable for graphics processing. In some instances, GPU 414 may also include general purpose processing capabilities, and may be referred to as a general-purpose GPU (GPGPU) when implementing general purpose processing tasks (i.e., non-graphics related tasks). The display processor 418 may also be specialized integrated circuit hardware that is designed to retrieve image content from the system memory 416, compose the image content into an image frame, and output the image frame to the display 103.

The processor 412 may execute various types of the applications 20. Examples of the applications 20 include web browsers, e-mail applications, spreadsheets, video games, other applications that generate viewable objects for display, or any of the application types listed in more detail above. The system memory 416 may store instructions for execution of the applications 20. The execution of one of the applications 20 on the processor 412 causes the processor 412 to produce graphics data for image content that is to be displayed and the audio data 21 that is to be played (possibly via integrated speaker 105). The processor 412 may transmit graphics data of the image content to the GPU 414 for further processing based on instructions or commands that the processor 412 transmits to the GPU 414.

The processor 412 may communicate with the GPU 414 in accordance with a particular application processing interface (API). Examples of such APIs include the DirectX® API by Microsoft®, the OpenGL® or OpenGL ES® by the Khronos group, and the OpenCL™; however, aspects of this disclosure are not limited to the DirectX, the OpenGL, or the OpenCL APIs, and may be extended to other types of APIs. Moreover, the techniques described in this disclosure are not required to function in accordance with an API, and the processor 412 and the GPU 414 may utilize any technique for communication.

The system memory 416 may be the memory for the source device 12. The system memory 416 may comprise one or more computer-readable storage media. Examples of the system memory 416 include, but are not limited to, a random-access memory (RAM), an electrically erasable programmable read-only memory (EEPROM), flash memory, or other medium that can be used to carry or store desired program code in the form of instructions and/or data structures and that can be accessed by a computer or a processor.

In some examples, the system memory 416 may include instructions that cause the processor 412, the GPU 414, and/or the display processor 418 to perform the functions ascribed in this disclosure to the processor 412, the GPU 414, and/or the display processor 418. Accordingly, the system memory 416 may be a computer-readable storage medium having instructions stored thereon that, when executed, cause one or more processors (e.g., the processor 412, the GPU 414, and/or the display processor 418) to perform various functions.

The system memory 416 may include a non-transitory storage medium. The term “non-transitory” indicates that the storage medium is not embodied in a carrier wave or a propagated signal. However, the term “non-transitory” should not be interpreted to mean that the system memory 416 is non-movable or that its contents are static. As one example, the system memory 416 may be removed from the source device 12 and moved to another device. As another example, memory, substantially similar to the system memory 416, may be inserted into the source device 12. In certain examples, a non-transitory storage medium may store data that can, over time, change (e.g., in RAM).

The user interface 420 may represent one or more hardware or virtual (meaning a combination of hardware and software) user interfaces by which a user may interface with the source device 12. The user interface 420 may include physical buttons, switches, toggles, lights or virtual versions thereof. The user interface 420 may also include physical or virtual keyboards, touch interfaces—such as a touchscreen, haptic feedback, and the like.

The processor 412 may include one or more hardware units (including so-called “processing cores”) configured to perform all or some portion of the operations discussed above with respect to one or more of the mixing unit 22, the audio encoder 24, the wireless connection manager 26, and the wireless communication units 30. The transceiver unit 422 may represent a unit configured to establish and maintain the wireless connection between the source device 12 and the sink device 14. The transceiver unit 422 may represent one or more receivers and one or more transmitters capable of wireless communication in accordance with one or more wireless communication protocols. The transceiver unit 422 may perform all or some portion of the operations of one or more of the wireless connection manager 26 and the wireless communication units 30.

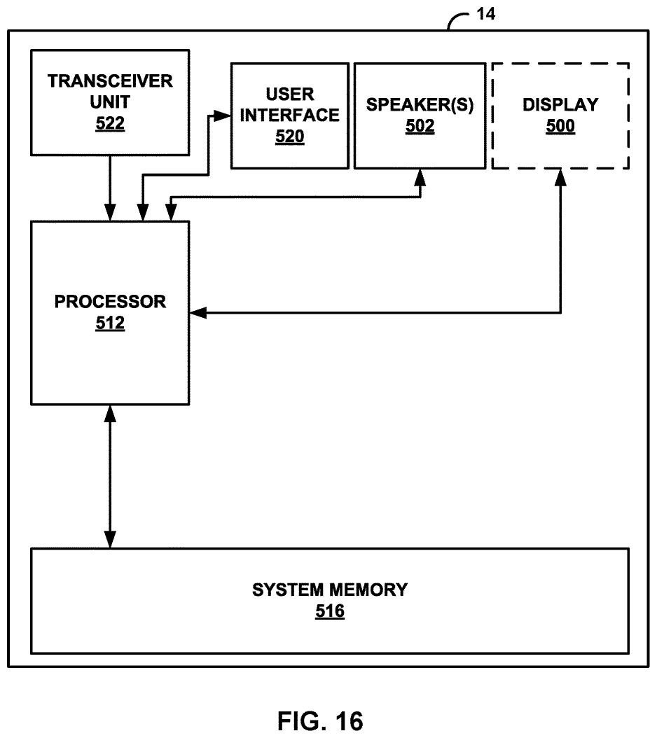

FIG. 16 is a block diagram illustrating exemplary components of the sink device 14 shown in the example of FIG. 1. Although the sink device 14 may include components similar to that of the source device 12 discussed above in more detail with respect to the example of FIG. 15, the sink device 14 may, in certain instances, include only a subset of the components discussed above with respect to the source device 12.

In the example of FIG. 16, the sink device 14 includes one or more speakers 502, a processor 512, a system memory 516, a user interface 520, and a transceiver unit 522. The processor 512 may be similar or substantially similar to the processor 412. In some instances, the processor 512 may differ from the processor 412 in terms of total processing capacity or may be tailored for low power consumption. The system memory 516 may be similar or substantially similar to the system memory 416. The speakers 502, the user interface 520, and the transceiver unit 522 may be similar to or substantially similar to the respective speakers 105, user interface 420, and transceiver unit 422. The sink device 14 may also optionally include a display 500, although the display 500 may represent a low power, low resolution (potentially a black and white light emitting diode—LED) display by which to communicate limited information, which may be driven directly by the processor 512.

The processor 512 may include one or more hardware units (including so-called “processing cores”) configured to perform all or some portion of the operations discussed above with respect to one or more of the wireless connection manager 40, the wireless communication units 42, and the audio decoder 44. The transceiver unit 522 may represent a unit configured to establish and maintain the wireless connection between the source device 12 and the sink device 14. The transceiver unit 522 may represent one or more receivers and one or more transmitters capable of wireless communication in accordance with one or more wireless communication protocols. The transceiver unit 522 may perform all or some portion of the operations of one or more of the wireless connection manager 40 and the wireless communication units 42.

The foregoing techniques may be performed with respect to any number of different contexts and audio ecosystems. A number of example contexts are described below, although the techniques should not be limited to the example contexts. One example audio ecosystem may include audio content, movie studios, music studios, gaming audio studios, channel-based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel-based audio content (e.g., in 2.0, 5.1, and 7.1) such as by using a digital audio workstation (DAW). The music studios may output channel-based audio content (e.g., in 2.0, and 5.1) such as by using a DAW. In either case, the coding engines may receive and encode the channel-based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel-based audio content for output by the delivery systems. Another example context in which the techniques may be performed comprises an audio ecosystem that may include broadcast recording audio objects, professional audio systems, consumer on-device capture, high-order ambisonics (HOA) audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into various representations for playback by one or more of the playback elements. For instance, a user of the mobile device may record (acquire a soundfield of) a live event (e.g., a meeting, a conference, a play, a concert, etc.), and code the recording into various representation, including higher order ambisonic HOA representations.

The mobile device may also utilize one or more of the playback elements to playback the coded soundfield. For instance, the mobile device may decode the coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a headset or headphones, e.g., to create realistic binaural sound.

In some examples, a particular mobile device may both acquire a soundfield and playback the same soundfield at a later time. In some examples, the mobile device may acquire a soundfield, encode the soundfield, and transmit the encoded soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of audio signals. For instance, the one or more DAWs may include audio plugins and/or tools which may be configured to operate with (e.g., work with) one or more game audio systems. In some examples, the game studios may output new stem formats that support audio format. In any case, the game studios may output coded audio content to the rendering engines which may render a soundfield for playback by the delivery systems.

The mobile device may also, in some instances, include a plurality of microphones that are collectively configured to record a soundfield, including 3D soundfields. In other words, the plurality of microphone may have X, Y, Z diversity. In some examples, the mobile device may include a microphone which may be rotated to provide X, Y, Z diversity with respect to one or more other microphones of the mobile device.

A ruggedized video capture device may further be configured to record a soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a soundfield that represents the action all around the user (e.g., water crashing behind the user, another rafter speaking in front of the user, etc.).

The techniques may also be performed with respect to an accessory enhanced mobile device, which may be configured to record a soundfield, including a 3D soundfield. In some examples, the mobile device may be similar to the mobile devices discussed above, with the addition of one or more accessories. For instance, a microphone, including an Eigen microphone, may be attached to the above noted mobile device to form an accessory enhanced mobile device. In this way, the accessory enhanced mobile device may capture a higher quality version of the soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a soundfield, including a 3D soundfield. Moreover, in some examples, headphone playback devices may be coupled to a decoder via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

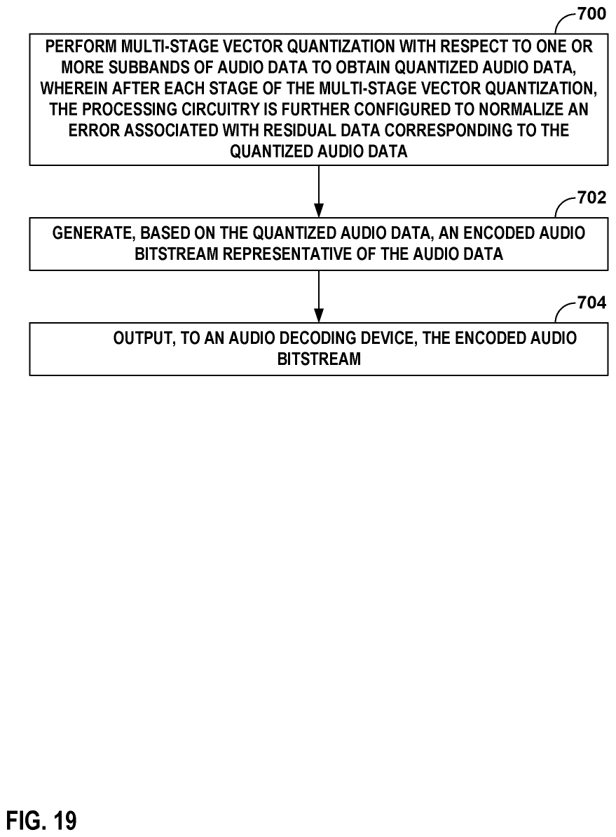

FIG. 19 is a flowchart illustrating example operation of the source device of FIG. 1 in performing the techniques described in this disclosure. The audio encoder 24 of the source device 12 may perform multi-stage vector quantization with respect to one or more subbands of the audio data to obtain quantized audio data. Prior to performing vector quantization (such as PVQ), the audio encoder 24 may apply a transform to the mixed audio data 23 to convert the mixed audio data 23 from the time domain to the frequency domain. The transform may include a modified discrete cosine transform (MDCT), whereupon the audio encoder 24 may divide the transformed audio data into the one or more subbands. The audio encoder 24 may next perform the multi-stage PVQ (in one example) to obtain the quantized audio data, which is another way to refer to indexes into the V-table that identify the matching vector.

The audio encoder 24 may apply each stage of the multi-stage PVQ iteratively (and possibly recursively) to obtain, after each stage, residual values. The audio encoder 24 may then normalize, after each stage of the multi-stage PVQ, the residual values (which are the result of subtracting the vector from the V-table from each subband of transformed audio data, where the difference may also be referred to as error values) (700). The audio encoder 24 may apply a L2-norm to the residual values to reduce the dynamic range, which may improve successive stages of application of the PVQ.

The audio encoder 24 may perform, after each PVQ stage, normalization to the error associated with the residual values to standardize the energy level and maximize the dynamic range of the error values associated with the residual values. The raw normalization level may not be quantized using 14 bits in a fixed-point signed representation. Further, the audio encoder 24 may also avoid local minima (per the example shown in FIG. 18) to potentially improve accuracy.

The audio encoder 24 may specify the vector indexes (or differences as residual data) in the encoded audio bitstream 31 after each stage of the multi-stage PVQ. The audio encoder 24 may then generate, based on the quantized audio data, the encoded audio bitstream 31 (which encapsulates the encoded audio data 25) representative of the audio data 23 along with the bit allocation (702). As noted above, the audio encoder 24 may specify the vector indexes as a stacked codeword for higher dimensionality MS-PVQ encoding. The audio encoder 24 may then interface with the wireless connection manager 26 to output, via one of the wireless communication units 30, the encoded audio bitstream 31 (possibly to sink device 14 or some intermediate device not shown in the example of FIG. 1) (704).

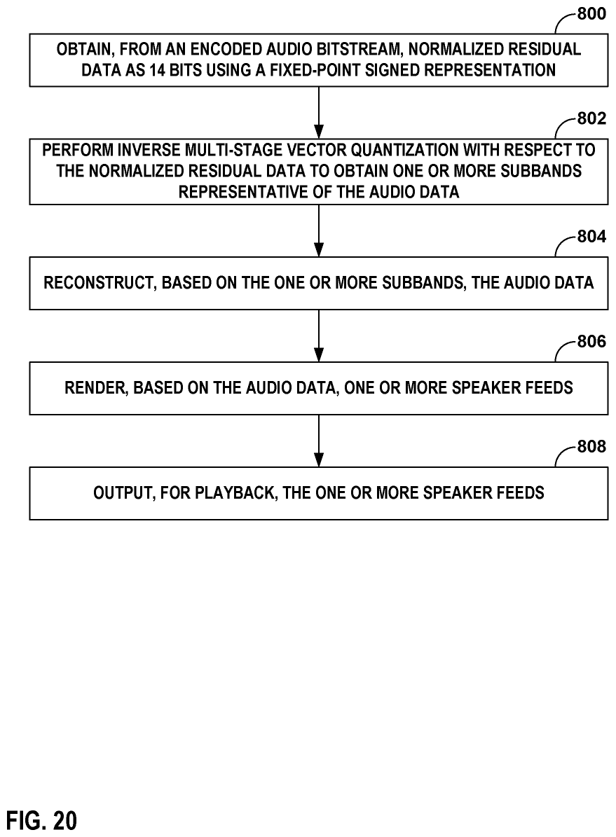

FIG. 20 is a flowchart illustrating example operation of the sink device of FIG. 1 in performing the techniques described in this disclosure. The audio decoder 44 may receive, via the transmission channel and the wireless connection manager 40, the encoded audio bitstream 31. The audio decoder 44 may perform inverse multi-stage vector quantization, based possibly on the bit allocation extracted from the encoded audio bitstream 31, with respect to the encoded audio bitstream 31 to obtain one or more subbands representative of the audio data 23. The audio decoder 44 may perform inverse operations to the audio encoder 24 to apply each stage of the inverse multi-stage PVQ (as one example) to obtain the normalized residual values as 14 bits using a fixed-point signed representation (800), adding the normalized residual values to the vector from the V-table signaled in the bitstream. The audio decoder 44 may then iteratively (and possibly recursively) perform each stage of the multi-stage PVQ to reconstruct the audio data 23 as mixed audio data 23′. That is, the audio encoder 44 may perform inverse multi-stage vector quantization with respect to the normalized residual data to obtain one or more subbands representative of the audio data 23 (802).

In order to reconstruct the audio data 23, the audio decoder 44 may reconstruct, based on the one or more subbands (recombined from the gain and shape vector), the audio data 23′ (804), where again the prime notation reflects that some loss occurs as a result of the PVQ process inasmuch as the PVQ process is not lossless. The audio decoder 44 may apply the inverse transform (inverse MDCT which may be denoted as iMDCT) to the audio data 23′ to convert the audio data 23′ from the frequency domain to the time domain. The audio decoder 44 may next render the audio data 23′ to speaker feeds (806), and output the speaker feeds to speakers 48 so that the speakers 48 may reproduce the soundfield (808).

In accordance with one or more techniques of this disclosure, a single generic representation of a soundfield may be utilized to render the soundfield on any of the foregoing playback environments. Additionally, the techniques of this disclosure enable a renderer to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a renderer to compensate with the other 6 speakers such that playback may be achieved on a 6.1 speaker playback environment.

Moreover, a user may watch a sports game while wearing headphones. In accordance with one or more techniques of this disclosure, the soundfield, including 3D soundfields, of the sports game may be acquired (e.g., one or more microphones and/or Eigen microphones may be placed in and/or around the baseball stadium). HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the source device 12 may perform a method or otherwise comprise means to perform each step of the method for which the source device 12 is described above as performing. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the source device 12 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the sink device 14 may perform a method or otherwise comprise means to perform each step of the method for which the sink device 14 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the sink device 14 has been configured to perform.

In this way, the techniques may enable the following aspects.

Aspect 1. A device configured to decode audio data, the device comprising: a memory configured to store an encoded audio bitstream representative of the audio data; and processing circuitry in communication with the memory, the processing circuitry configured to: obtain, from the encoded audio bitstream, normalized residual data as 14 bits using a fixed-point signed representation; perform inverse multi-stage vector quantization with respect to the normalized residual data to obtain one or more subbands representative of the audio data; reconstruct, based on the one or more subbands, the audio data; render, based on the audio data, one or more speaker feeds; and output, for playback, the one or more speaker feeds.

Aspect 2. The device of aspect 1, wherein the processing circuitry is configured to recursively perform each stage of the inverse multi-stage vector quantization with respect to the encoded audio bitstream to obtain the one or more subbands representative of the audio data.

Aspect 3. The device of any of aspects 1 and 2, wherein the encoded audio bitstream includes, for each stage of the multi-stage vector quantization, residual data for which an error associated with the normalized residual data has been normalized to standardize energy prior to performing each successive stage of the multi-stage vector quantization.

Aspect 4. The device of aspect 3, wherein the residual data is normalized according to an L2 norm.

Aspect 5. The device of any of aspects 1-4,
wherein a bit allocation used to encode the encoded audio bitstream is selected to avoid local minima, wherein the encoded audio bitstream specifies the bit allocation, and wherein the processing circuitry is further configured to extract, based on the bit allocation, encoded audio samples prior to performing the inverse multi-stage vector quantization.

Aspect 6. The device of any of aspects 1-4, wherein the processing circuitry is configured to perform inverse multi-stage pyramid vector quantization with respect to the encoded audio bitstream to obtain the one or more subbands representative of the audio data.

Aspect 7. The device of any of aspects 1-6, wherein the encoded audio bitstream includes, for a first stage of a multi-stage vector quantization, a coarse quantization value for each of the one or more subbands and a fine quantization value for each of the one or more subbands.

Aspect 8. The device of aspect 7, wherein the coarse quantization value is selected based on a type of the audio data, and wherein the type of the audio data includes one of speech type, a tonal music type, and a non-tonal music type, and wherein the type of the audio data corresponds to a different vector table used for performing the multi-stage vector quantization.

Aspect 9. The device of aspect 8, wherein the encoded audio bitstream includes a syntax element identifying the type of the audio data, wherein the processing circuitry is configured to perform the inverse multi-stage vector quantization based on the syntax element to select the corresponding different vector table.

Aspect 10. The device of any of aspects 7-9, wherein the fine quantization value is allocated based on the coarse quantization value.

Aspect 11. The device of any of aspects 1-10, wherein the inverse multi-stage vector quantization has a limited number of stages that is greater than one and less than a maximum number of stages, the maximum number of stages limited by a number of bits allocated for each of the one or more subbands.

Aspect 12. The device of any of aspects 1-11, wherein the processing circuitry is configured to perform the inverse multi-stage vector quantization to facilitate a scalable bitrate in which a bitrate for the encoded audio bitstream scales between a low bitrate and a relatively higher bitrate.

Aspect 13. The device of aspect 12, wherein the low bitrate is equal to or less than 82 Kilobits per second—Kbps, and wherein the relatively higher bitrate is equal to or greater than one Megabits per second—Mbps.

Aspect 14. The device of any of aspects 1-13, wherein the one or more subbands exclude one or more low energy subbands representative of the audio data that were filtered, based on an energy threshold, by an audio encoder that encoded the audio data to obtain the encoded audio bitstream.

Aspect 15. The device of aspect 14, wherein bits allocated to the low energy subbands are reallocated by the audio encoder to the one or more subbands.

Aspect 16. The device of any of aspects 1-15, wherein bits are allocated to each of the one or more subbands across each stage of a multi-stage vector quantization process performed by the audio encoder that encoded the audio data to obtain the encoded audio bitstream.

Aspect 17. The device of any of aspects 1-16, wherein the audio encoded bitstream includes entropy encoded stacked codewords that combine multiple different indices that reference a vector table, and wherein the processing circuitry is configured to: entropy decode the entropy encoded stacked codeword to obtain the stacked codewords; parse the stacked codewords to obtain multiple singular codewords that each reference the vector table; and perform, based on the multiple singular codewords that reference the vector table, the inverse multi-stage vector quantization to obtain the one or more subbands representative of the audio data.

Aspect 18. A method for decoding audio data, the method comprising: obtaining an encoded audio bitstream representative of the audio data that includes normalized residual data as 14 bits using a fixed-point signed representation; and performing inverse multi-stage vector quantization with respect to the normalized residual data to obtain one or more subbands representative of the audio data; reconstructing, based on the one or more subbands, the audio data; rendering, based on the audio data, one or more speaker feeds; and outputting, for playback, the one or more speaker feeds.

Aspect 19. The method of aspect 18, wherein performing the inverse multi-stage vector quantization includes recursively performing each stage of the inverse multi-stage vector quantization with respect to the encoded audio bitstream to obtain the one or more subbands representative of the audio data.

Aspect 20. The method of any of aspects 18 and 19, wherein the encoded audio bitstream includes, for each stage of the multi-stage vector quantization, residual data for which an error associated with the normalized residual data has been normalized to standardize energy prior to performing each successive stage of the multi-stage vector quantization.

Aspect 21. The method of aspect 20, wherein the residual data is normalized according to an L2 norm.

Aspect 22. The method of any of aspects 18-21, wherein a bit allocation used to encode the encoded audio bitstream is selected to avoid local minima, wherein the encoded audio bitstream specifies the bit allocation, and wherein the method further comprises extracting, based on the bit allocation, encoded audio samples prior to performing the inverse multi-stage vector quantization.

Aspect 23. The method of any of aspects 18-21, wherein performing the inverse multi-stage vector quantization includes performing inverse multi-stage pyramid vector quantization with respect to the encoded audio bitstream to obtain the one or more subbands representative of the audio data.

Aspect 24. The method of any of aspects 18-23, wherein the encoded audio bitstream includes, for a first stage of a multi-stage vector quantization, a coarse quantization value for each of the one or more subbands and a fine quantization value for each of the one or more subbands.

Aspect 25. The method of aspect 24, wherein the coarse quantization value is selected based on a type of the audio data, and wherein the type of the audio data includes one of speech type, a tonal music type, and a non-tonal music type, and wherein the type of the audio data corresponds to a different vector table used for performing the multi-stage vector quantization.

Aspect 26. The method of aspect 25, wherein the encoded audio bitstream includes a syntax element identifying the type of the audio data, wherein performing the inverse multi-stage vector quantization includes performing the inverse multi-stage vector quantization based on the syntax element to select the corresponding different vector table.

Aspect 27. The method of any of aspects 24-26, wherein the fine quantization value is allocated based on the coarse quantization value.

Aspect 28. The method of any of aspects 18-27, wherein the inverse multi-stage vector quantization has a limited number of stages that is greater than one and less than a maximum number of stages, the maximum number of stages limited by a number of bits allocated for each of the one or more subbands.

Aspect 29. The method of any of aspects 18-28, wherein performing the inverse multi-stage vector quantization includes performing the inverse multi-stage vector quantization to facilitate a scalable bitrate in which a bitrate for the encoded audio bitstream scales between a low bitrate and a relatively higher bitrate.

Aspect 30. The method of aspect 29, wherein the low bitrate is equal to or less than 82 Kilobits per second—Kbps, and wherein the relatively higher bitrate is equal to or greater than one Megabits per second—Mbps.

Aspect 31. The method of any of aspects 18-30, wherein the one or more subbands exclude one or more low energy subbands representative of the audio data that were filtered, based on an energy threshold, by an audio encoder that encoded the audio data to obtain the encoded audio bitstream.

Aspect 32. The method of aspect 31, wherein bits allocated to the low energy subbands are reallocated by the audio encoder to the one or more subbands.

Aspect 33. The method of any of aspects 18-32, wherein bits are allocated to each of the one or more subbands across each stage of a multi-stage vector quantization process performed by the audio encoder that encoded the audio data to obtain the encoded audio bitstream.

Aspect 34. The method of any of aspects 18-33, wherein the audio encoded bitstream includes entropy encoded stacked codewords that combine multiple different indices that reference a vector table, and wherein the method further comprises: entropy decoding the entropy encoded stacked codeword to obtain the stacked codewords; and parsing the stacked codewords to obtain multiple singular codewords that each reference the vector table, wherein performing the inverse multi-stage vector quantization comprises performing, based on the multiple singular codewords that reference the vector table, the inverse multi-stage vector quantization to obtain the one or more subbands representative of the audio data.

Aspect 35. A non-transitory computer-readable storage media having stored thereon instructions that, when executed, cause one or more processors to: obtain an encoded audio bitstream representative of audio data that includes normalized residual data as 14 bits using a fixed-point signed representation; perform inverse multi-stage vector quantization with respect to the normalized residual data to obtain one or more subbands representative of the audio data; reconstruct, based on the one or more subbands, the audio data; render, based on the audio data, one or more speaker feeds; and output, for playback, the one or more speaker feeds.

Aspect 36. A device configured to encode audio data, the device comprising: a memory configured to store the audio data; and processing circuitry in communication with the memory, the processing circuitry configured to: perform multi-stage vector quantization with respect to one or more subbands of the audio data to obtain quantized audio data, wherein after each stage of the multi-stage vector quantization, the processing circuitry is further configured to normalize an error associated with residual data corresponding to the quantized audio data; generate, based on the quantized audio data, an encoded audio bitstream representative of the audio data; and output, to an audio decoding device, the encoded audio bitstream.

Aspect 37. The device of aspect 36, wherein the quantized audio data includes 14 bits in a fixed-point signed representation.

Aspect 38. The device of any of aspects 36 and 37, wherein the processing circuitry is configured to: select a bit allocation used that avoids local minima; and specify, in the encoded audio bitstream, the bit allocation.

Aspect 39. The device of any of aspects 36-38, wherein the processing circuitry is configured to: stack multiple codewords that represent indices that reference a vector table to obtain a stacked codeword; entropy encode the stacked codeword to obtain an entropy encoded stacked codeword; and specify, in the audio encoded bitstream, the entropy encoded stacked codeword.

Aspect 40. The device of aspect 39, wherein the stacked codeword represents multiple shape vectors obtained from the one or more subbands of the audio data.

Aspect 41. The device of any of aspects 36-40, wherein the processing circuitry is configured to recursively perform each stage of the multi-stage vector quantization with respect to the one or more subbands of the audio data to obtain the encoded audio bitstream.

Aspect 42. The device of any of aspects 36-41, wherein the processing circuitry is configured to, when performing the multi-stage vector quantization, normalize residual data to standardize energy prior to performing each successive stage of the multi-stage vector quantization.

Aspect 43. The device of aspect 42, wherein the processing circuitry is configured to normalize the residual data according to an L2 norm.

Aspect 44. The device of any of aspects 36-43, wherein the processing circuitry is configured to perform multi-stage pyramid vector quantization with respect to the one or more subbands of the audio data to obtain the quantized audio data.

Aspect 45. The device of any of aspects 36-44, wherein the processing circuitry is configured to obtain, for a first stage of the multi-stage vector quantization, a coarse quantization value for each of the one or more subbands and a fine quantization value for each of the one or more subbands.

Aspect 46. The device of aspect 45, wherein the processing circuitry is configured to select a coarse quantization value based on a type of the audio data, and wherein the type of the audio data includes one of speech type, a tonal music type, and a non-tonal music type, and wherein the type of the audio data corresponds to a different vector table used for performing the multi-stage vector quantization.

Aspect 47. The device of aspect 46, wherein the processing circuitry is configured to specify, in the encoded audio bitstream, a syntax element identifying the type of the audio data that identifies the different vector table used for performing the multi-stage vector quantization.

Aspect 48. The device of any of aspects 45-47, wherein the processing circuitry is configured to allocate the fine quantization value based on the coarse quantization value.

Aspect 49. The device of any of aspects 36-48, wherein the multi-stage vector quantization has a limited number of stages that is greater than one and less than a maximum number of stages, the maximum number of stages limited by a number of bits allocated for each of the one or more subbands.

Aspect 50. The device of any of aspects 36-49, wherein the processing circuitry is configured to perform the multi-stage vector quantization to facilitate a scalable bitrate in which a bitrate for the encoded audio bitstream scales between a low bitrate and a relatively higher bitrate.

Aspect 51. The device of aspect 50, wherein the low bitrate is equal to or less than 82 Kilobits per second—Kbps, and wherein the relatively higher bitrate is equal to or greater than one Megabits per second—Mbps.

Aspect 52. The device of any of aspects 36-51, wherein the processing circuitry is configured to filter, from the one or more subbands and based on an energy threshold, one or more low energy subbands representative of the audio data.

Aspect 53. The device of aspect 52, wherein the processing circuitry is configured to reallocate bits allocated to the low energy subbands to the one or more subbands.

Aspect 54. The device of any of aspects 36-53, wherein the processing circuitry allocates bits to each of the one or more subbands across each stage of the multi-stage vector quantization to obtain the quantized audio data.

Aspect 55. A method of encoding audio data, the method comprising: performing multi-stage vector quantization with respect to one or more subbands of the audio data to obtain quantized audio data, wherein after each stage of the multi-stage vector quantization, the method further comprises normalizing an error associated with residual data corresponding to the quantized audio data; generating, based on the quantized audio data, an encoded audio bitstream representative of the audio data; and outputting, to an audio decoding device, the encoded audio bitstream.

Aspect 56. The method of aspect 55, wherein the quantized audio data includes 14 bits in a fixed-point signed representation.

Aspect 57. The method any of aspects 55 and 56, wherein performing the multi-stage vector quantization comprises recursively performing each stage of the multi-stage vector quantization with respect to the one or more subbands of the audio data to obtain the encoded audio bitstream.

Aspect 58. The method of any of aspects 55-57, wherein the method further comprises: stacking multiple codewords that represent indices that reference a vector table to obtain a stacked codeword; entropy encoding the stacked codeword to obtain an entropy encoded stacked codeword; and specifying, in the audio encoded bitstream, the entropy encoded stacked codeword.

Aspect 59. The method of aspect 58, wherein the stacked codeword represents multiple shape vectors obtained from the one or more subbands of the audio data.

Aspect 60. The method of any of aspects 55-59, wherein normalizing the residual data includes normalizing the residual data to standardize energy prior to performing each successive stage of the multi-stage vector quantization.

Aspect 61. The method of any of aspects 55-60, wherein normalizing the residual data comprises normalizing the residual data according to an L2 norm.

Aspect 62. The method of any of aspects 55-61, wherein performing the multi-stage vector quantization comprises performing multi-stage pyramid vector quantization with respect to the one or more subbands of the audio data to obtain the quantized audio data.

Aspect 63. The method of any of aspects 55-62, further comprising obtaining, for a first stage of the multi-stage vector quantization, a coarse quantization value for each of the one or more subbands and a fine quantization value for each of the one or more subbands.

Aspect 64. The method of aspect 63, further comprising selecting a coarse quantization value based on a type of the audio data, and wherein the type of the audio data includes one of speech type, a tonal music type, and a non-tonal music type, and wherein the type of the audio data corresponds to a different vector table used for performing the multi-stage vector quantization.

Aspect 65. The method of aspect 64, further comprising specifying, in the encoded audio bitstream, a syntax element identifying the type of the audio data that identifies the different vector table used for performing the multi-stage vector quantization.

Aspect 66. The method of any of aspects 63 and 64, further comprising allocating the fine quantization value based on the coarse quantization value.

Aspect 67. The method of any of aspects 55-66, wherein the multi-stage vector quantization has a limited number of stages that is greater than one and less than a maximum number of stages, the maximum number of stages limited by a number of bits allocated for each of the one or more subbands.

Aspect 68. The method of any of aspects 55-66, wherein performing the multi-stage vector quantization comprises performing the multi-stage vector quantization to facilitate a scalable bitrate in which a bitrate for the encoded audio bitstream scales between a low bitrate and a relatively higher bitrate.

Aspect 69. The method of aspect 68, wherein the low bitrate is equal to or less than 82 Kilobits per second—Kbps, and wherein the relatively higher bitrate is equal to or greater than one Megabits per second—Mbps.

Aspect 70. The method of any of aspects 55-69, further comprising filtering, from the one or more subbands and based on an energy threshold, one or more low energy subbands representative of the audio data.

Aspect 71. The method of aspect 70, further comprising reallocating bits allocated to the low energy subbands to the one or more subbands.

Aspect 72. The method of any of aspects 55-71, further comprising allocating bits to each of the one or more subbands across each stage of the multi-stage vector quantization to obtain the quantized audio data.

Aspect 73. A non-transitory computer-readable medium having stored thereon instructions that, when executed, cause one or more processors to: perform multi-stage vector quantization with respect to one or more subbands of audio data to obtain quantized audio data, wherein after each stage of the multi-stage vector quantization, the instructions further including instructions, that when executed cause the one or more processors to normalize an error associated with residual data corresponding to the quantized audio data; generate, based on the quantized audio data, an encoded audio bitstream representative of the audio data; and output, to an audio decoding device, the encoded audio bitstream.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some examples, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the techniques have been described. These and other aspects of the techniques are within the scope of the following claims.

What is claimed is:

1. A device configured to decode audio data, the device comprising:
a memory configured to store an encoded audio bitstream representative of the audio data; and
processing circuitry in communication with the memory, the processing circuitry configured to:
obtain, from the encoded audio bitstream, normalized residual data as 14 bits using a fixed-point signed representation;
perform inverse multi-stage vector quantization with respect to the normalized residual data to obtain one or more subbands representative of the audio data;
reconstruct, based on the one or more subbands, the audio data;
render, based on the audio data, one or more speaker feeds; and
output, for playback, the one or more speaker feeds.

2. The device of claim 1, wherein the processing circuitry is configured to recursively perform each stage of the inverse multi-stage vector quantization with respect to the encoded audio bitstream to obtain the one or more subbands representative of the audio data.

3. The device of claim 1, wherein the encoded audio bitstream includes, for each stage of the inverse multi-stage vector quantization, residual data for which an error associated with the normalized residual data has been normalized to standardize energy prior to performing each successive stage of the inverse multi-stage vector quantization.

4. The device of claim 3, wherein the residual data is normalized according to an L2 norm.

5. The device of claim 1,
wherein a bit allocation used to encode the encoded audio bitstream is selected to avoid local minima,
wherein the encoded audio bitstream specifies the bit allocation, and
wherein the processing circuitry is further configured to extract, based on the bit allocation, encoded audio samples prior to performing the inverse multi-stage vector quantization.

6. The device of claim 1, wherein the processing circuitry is configured to perform inverse multi-stage pyramid vector quantization with respect to the encoded audio bitstream to obtain the one or more subbands representative of the audio data.

7. The device of claim 1, wherein the encoded audio bitstream includes, for a first stage of a multi-stage vector quantization, a coarse quantization value for each of the one or more subbands and a fine quantization value for each of the one or more subbands.

8. The device of claim 7,
wherein the coarse quantization value is selected based on a type of the audio data, and
wherein the type of the audio data includes one of speech type, a tonal music type, and a non-tonal music type, and
wherein the type of the audio data corresponds to a different vector table used for performing the multi-stage vector quantization.

9. The device of claim 8,
wherein the encoded audio bitstream includes a syntax element identifying the type of the audio data,
wherein the processing circuitry is configured to perform the inverse multi-stage vector quantization based on the syntax element to select a corresponding different vector table.

10. The device of claim 7, wherein the fine quantization value is allocated based on the coarse quantization value.

11. The device of claim 1, wherein the inverse multi-stage vector quantization has a limited number of stages that is greater than one and less than a maximum number of stages, the maximum number of stages limited by a number of bits allocated for each of the one or more subbands.

12. The device of claim 1, wherein the processing circuitry is configured to perform the inverse multi-stage vector quantization to facilitate a scalable bitrate in which a bitrate for the encoded audio bitstream scales between a low bitrate and a relatively higher bitrate.

13. The device of claim 12,
wherein the low bitrate is equal to or less than 82 Kilobits per second—Kbps, and
wherein the relatively higher bitrate is equal to or greater than one Megabits per second—Mbps.

14. The device of claim 1, wherein the one or more subbands exclude one or more low energy subbands representative of the audio data that were filtered, based on an energy threshold, by an audio encoder that encoded the audio data to obtain the encoded audio bitstream.

15. The device of claim 14, wherein bits allocated to the low energy subbands are reallocated by the audio encoder to the one or more subbands.

16. The device of claim 1, wherein bits are allocated to each of the one or more subbands across each stage of a multi-stage vector quantization process performed by an audio encoder that encoded the audio data to obtain the encoded audio bitstream.

17. The device of claim 1, wherein the encoded audio bitstream includes entropy encoded stacked codewords that combine multiple different indices that reference a vector table, and
wherein the processing circuitry is configured to:
entropy decode the entropy encoded stacked codeword to obtain the stacked codewords;
parse the stacked codewords to obtain multiple singular codewords that each reference the vector table; and
perform, based on the multiple singular codewords that reference the vector table, the inverse multi-stage vector quantization to obtain the one or more subbands representative of the audio data.

18. The device of claim 1, further comprising one or more speakers configured to reproduce, based on the one or more speaker feeds, a soundfield represented by the audio data.

19. A method for decoding audio data, the method comprising:
obtaining an encoded audio bitstream representative of the audio data that includes normalized residual data as 14 bits using a fixed-point signed representation; and
performing inverse multi-stage vector quantization with respect to the normalized residual data to obtain one or more subbands representative of the audio data;
reconstructing, based on the one or more subbands, the audio data;
rendering, based on the audio data, one or more speaker feeds; and
outputting, for playback, the one or more speaker feeds.

20. A device configured to encode audio data, the device comprising:
a memory configured to store the audio data; and
processing circuitry in communication with the memory, the processing circuitry configured to:
perform multi-stage vector quantization with respect to one or more subbands of the audio data to obtain quantized audio data, wherein after each stage of the multi-stage vector quantization, the processing circuitry is further configured to normalize an error associated with residual data corresponding to the quantized audio data;
generate, based on the quantized audio data, an encoded audio bitstream representative of the audio data; and
output, to an audio decoding device, the encoded audio bitstream.
